(19) United States
(12) Patent Application Publication
(10) Pub. No.: US 2024/0353825 A1
(43) Pub. Date: Oct. 24, 2024

(54) WORKFLOW AND CONTEXTUAL DRIVE KNOWLEDGE ENCODING

(71) Applicant: LYTT LIMITED, Middlesex (GB)

(72) Inventors: Pradyumna THIRUVENKATANATHAN, Twickenham, London (GB); Tommy LANGNES, Weybridge, Surrey (GB)

(73) Assignee: LYTT LIMITED, Middlesex (GB)

(21) Appl. No.: 18/291,784

(22) PCT Filed: Jul. 30, 2021
(86) PCT No.: PCT/EP2021/071414

§ 371 Date: Jan. 24, 2024

(51) Int. Cl. G05B 23/02

(52) U.S. Cl. CPC G05B 23/0221; G05B 23/0229; G05B 23/027; G05B 23/0283

(57) ABSTRACT

A method of workflow selection and event detection comprises: receiving, on a user interface, a plurality of selections from a user, wherein the plurality of selections identifies a plurality of time series data elements; correlating the plurality of selections with a plurality of workflows, wherein each workflow of the plurality of workflows defines a set of associated time series data elements; identifying a first workflow of the plurality of workflows associated with the plurality of selections; retrieving a first set of time series data elements associated with the first workflow; and identifying an event using the first set of time series data elements.

### CROSS-REFERENCE TO RELATED APPLICATIONS

This application is a 35 U.S.C. § 371 national stage application of PCT/EP2021/071414 filed Jul. 30, 2021 and entitled “Workflow and Contextual Drive Knowledge Encoding,” which is hereby incorporated herein by reference in its entirety for all purposes.

### STATEMENT REGARDING FEDERALLY SPONSORED RESEARCH OR DEVELOPMENT

Not applicable.

### BACKGROUND

Data is generated by instrumentation and sensors, for example, in chemical plants and wellbore environments. The data can generally be monitored by computers and personnel for any fluctuations and abnormalities in order to control the operation, for example, to react to alarms that are set off due to readings that exceed thresholds in plant or wellbore operation. The data can also be stored for analysis.

### SUMMARY

In some aspects, a method of workflow selection and event detection comprises: receiving, on a user interface, a plurality of selections from a user, wherein the plurality of selections identifies a plurality of time series data elements; correlating the plurality of selections with a plurality of workflows, wherein each workflow of the plurality of workflows defines a set of associated time series data elements, identifying a first workflow of the plurality of workflows associated with the plurality of selections; retrieving a first set of time series data elements associated with the first workflow; and identifying an event using the first set of time series data elements.

In some aspects, a system comprises: a memory storing a workflow application; and a processor, wherein the workflow application, when executed on the process, configures the processor to: receive, on a user interface, a plurality of selections from a user, wherein the plurality of selections identifies a plurality of time series data elements; correlate the plurality of selections with a plurality of workflows, wherein each workflow of the plurality of workflows defines a set of associated time series data elements; identify a first workflow of the plurality of workflows associated with the plurality of selections; retrieve a first set of time series data elements associated with the first workflow; and identify an event using the first set of time series data elements.

In some aspects, method for knowledge graph generation comprises: receiving a plurality of queries from a plurality of users, wherein the plurality of queries request time series data elements from a plurality of time series data elements; correlating the user queries between two or more users of the plurality of users; determining that the user queries of the two or more users of the plurality of users are correlated; correlating the time series data elements in the user queries of the two or more users; identifying a set of time series data elements based on the correlating; and generating a knowledge graph, wherein the knowledge graph comprises the set of time series data elements as facts, and the correlation of the time series data elements as relationships between the facts.

Embodiments described herein comprise a combination of features and characteristics intended to address various shortcomings associated with certain prior devices, systems, and methods. The foregoing has outlined rather broadly the features and technical characteristics of the disclosed embodiments in order that the detailed description that follows may be better understood. The various characteristics and features described above, as well as others, will be readily apparent to those skilled in the art upon reading the following detailed description, and by referring to the accompanying drawings. It should be appreciated that the conception and the specific embodiments disclosed may be readily utilized as a basis for modifying or designing other structures for carrying out the same purposes as the disclosed embodiments. It should also be realized that such equivalent constructions do not depart from the spirit and scope of the principles disclosed herein.

### BRIEF DESCRIPTION OF THE DRAWINGS

For a detailed description of the preferred embodiments of the invention, reference will now be made to the accompanying drawings in which:

FIG. 1 is a schematic diagram of embodiments of the disclosed computer system that utilizes machine learning models to determine workflow from time series data using feedback from an application interface.

FIG. 2 is a schematic diagram of embodiments of the disclosed computer system that utilizes machine learning models to present sub-features in time series data or to present a solution that is associated with sub-features.

FIG. 3 is a schematic diagram of embodiments of the disclosed computer system that utilizes machine learning models to present a solution that is associated with features.

FIG. 4 is a schematic diagram of embodiments of the disclosed computer system that utilizes machine learning models to identify features in time series data and train the machine learning models using feedback from an application interface.

FIG. 5 is a schematic diagram of embodiments of the disclosed computer system that utilizes machine learning models to determine features are related to one another.

FIGS. 6A and 6B are schematic diagrams illustrating how time series data can be obtained for input to the disclosed computer systems.

FIG. 7 illustrates a schematic process flow for a knowledge encoder process according to some aspects.

FIG. 8A illustrates a schematic process flow for a knowledge encoder process according to some other aspects.

FIG. 8B illustrates a schematic process flow for a digital twin according to some other aspects.

FIG. 9 illustrates a schematic diagram of a computer system that can implement any of the components of the systems in FIGS. 1-7.

### DETAILED DESCRIPTION

Unless otherwise specified, any use of any form of the terms “connect,” “engage,” “couple.” “attach,” or any other term describing an interaction between elements is not meant to limit the interaction to direct interaction between the elements and may also include indirect interaction between the elements described. In the following discussion and in the claims, the terms “including” and “comprising” are used in an open-ended fashion, and thus should be interpreted to mean “including, but not limited to . . . ”. Reference to up or down will be made for purposes of description with “up,” “upper,” “upward,” “upstream,” or “above” meaning toward the surface of the wellbore and with “down,” “lower,” “downward,” “downstream,” or “below” meaning toward the terminal end of the well, regardless of the wellbore orientation. Reference to inner or outer will be made for purposes of description with “in,” “inner,” or “inward” meaning towards the central longitudinal axis of the wellbore and/or wellbore tubular, and “out,” “outer,” or “outward” meaning towards the wellbore wall. As used herein, the term “longitudinal” or “longitudinally” refers to an axis substantially aligned with the central axis of the wellbore tubular, and “radial” or “radially” refer to a direction perpendicular to the longitudinal axis. The various characteristics mentioned above, as well as other features and characteristics described in more detail below, will be readily apparent to those skilled in the art with the aid of this disclosure upon reading the following detailed description of the embodiments, and by referring to the accompanying drawings.

In some contexts, machine learning models can be applied to systems that collect data. These can include data analytic models that operate on stored data over time. An expert user is generally required to observe the data and provide the insights needed to analyze the data. For example, correlations between certain types of data can be provided by an expert user, and a model can then be constructed that uses the insights with the data. This process requires in initial set of insights and also tends to operate on stored data to provide the analysis well after the data has been obtained. These types of systems cannot provide real time feedback, and they do not automatically provide insights into the data other than those initially identified by the experts.

Disclosed herein are methods and systems that utilize machine learning models and feedback from an application interface to determine various features of time series data such as sensor signals, inputs, control signals, and the like, and provide a better understand of the environment (e.g., industrial plant, processing facilities, production facilities, wellbores, etc.) from which the time series data originated. As the algorithms for machine learning mature and become standardized, implementing machine learning models in data analysis, especially in the context of chemical plants, wellbore environments, and other industrial settings, can provide a better understanding of the operation of plants and wellbores.

The models and processes described herein can allow for any time series data in any setting that uses or obtains data (e.g., industrial settings, internet of things (IOT) systems, health systems, etc.) to be utilized to identify various workflows, events, and associated solutions. The time series data can be provided by a plurality of sensors. In some aspects, the system can perform correlations on the time series data and/or features derived from the time series data to determine any relationships within the data, which can be expressed in some instances as similarity scores. The systems can also be used to observe the interaction of a plurality of users with the system to generate user feedback based on the presentation of data representative of the time series data. The correlations within the time series data and/or the feedback can then be used as an input into a machine learning model and/or used to label the data set used to train another machine learning model. The model can then be retrained over time to improve and/or identify new events. This can be seen as a self-learning and/or self-labeling system that can be used across a variety of industries where the system learns during use, as opposed to requiring an initial identification of the information that is considered relevant to the models. In other words, the present systems and methods self-identify the variables, sensor inputs, and combinations that can then be used in various machine learning models to identify and predict events, problems, and solutions. This can improve a variety of systems by making the models more accurate, operate faster while potentially reducing or eliminating the need for any initial expert guidance on the relevant parameters or design of the models.

The system can also develop contextually drive workflows. As the correlations within the time series data and/or the feedback are identified and one or more machine learning models are selected, an association between the time series data, correlations, and the models can be developed. For example, the selection of a specific set of sensor data being viewed by a user or operator followed by the running of a specific machine learning model to attempt to look for an event or error can form an association between the model and the initial data analysis. In many instances, the model can rely on data as inputs that it not in the initial data analysis. The association can then help to identify which models will be used and even which data may be relevant to update the model.

The resulting associations between the data, the models, and the workflows of the users looking at data, running models, and finding outputs can be used to develop knowledge graphs over time, which an occur across users and locations. The knowledge graph can then define relationships between facts or data (e.g., the selected sensor data, event identifications, etc.) and knowledge such as the identification of events. This can allow for model development over time that does not rely on specific data scientists to examine data and determine which data should be linked with which models prior to developing and training the models. Rather, the knowledge of a user base can be captured through observation and used within an organization. This may allow for the knowledge to be standardized across an organization or area of development. For example, a wellbore operator may be able to identify an event even if a new analyst is using the system for the first time as they may be guided to the proper data set and analysis models by the system.

The use of the associations between the models and data can allow for the contextual drive workflows to be captured as noted above. In some aspects, this can allow for an identification of the proper model to use in context based on the data being referenced by a user. This may allow for better utilization of existing models without requiring a user to be aware of all of the models available.

The contextual workflows can also be used to identify thresholds for detecting events or anomalies within the data. The analysis of data across many users can establish clusters of information. The continued analysis and association of the clusters with models and results can be used to identify when an event is present and when an event is absent in the data. The system can then set thresholds for anomaly detection (e.g., detecting when an event is present even if not identifying a specific event) based on feedback from users. The thresholds may define values, ranges, and/or model outputs, any of which can be based on a plurality of time series data elements such as combination of data elements and the like as combinatorial readings. This information can also be included in a knowledge graph as part of the learnings of the system.

As used herein, the term “time series data” refers to data that is collected over time and can be labeled (e.g., timestamped) such that the particular time which the data value is collected is associated with the data value. “Time series data” can be displayed to a user and updated periodically to show new time series data along with historical time series data over a corresponding time period. Examples of time series data can include any sensor inputs output over time, derivatives of sensor data, combinations of sensor data, model outputs derived from sensor data, or other time based data inputs, observed data (e.g., healthcare diagnosis, lab testing, etc.), or any other data entered over time.

As disclosed herein, time series data generated in various setting can include data generated by a multitude of sensors or data entries. For example, most industrial plants contain many temperature sensors, pressure sensors, flow sensors, position sensors (e.g., to indicate the positioning of a valve, hatch, etc.), fluid level sensors, and the like. The resulting data can be used in various systems to determine features of the system such as a state of a unit (operating, filling, emptying, etc.), a type and flow rate of a fluid, fluid stream compositions, and the like, using various system models that can then also generate additional time series data (e.g., a fluid level determined from a plurality of other sensor data). In some instances, various sensor data can be used to determine the presence of one or more features such as anomalies or events. As used herein, an anomaly or event can comprise any occurrence within the relevant setting that is determined based on an analysis of the time series data, and the two terms can be used interchangeably. The anomalies or events can represent problems associated with the system, occurrences of various events (e.g., non-continuous events), states of the process(es), or the like. For example, acoustic sensor data can be used to detect a wellbore event such as fluid inflow within a wellbore. Similarly, wear in a train wheel bearing can be determined based on temperature sensor data along with acoustic information for the wheel. In still another example, a medical diagnosis (e.g., an anomaly or event in the patient's health) can be made based on various observations, measurements, and/or lab data obtained during a course of treatment for a patient.

The event detection process can comprise using the time series data to determine the presence of one or more features. Features can comprise one or more values or transformations determined from the time series data. For example, frequency analysis of various signals can be performed by transforming a data sample into the frequency domain, using for example, a suitable Fourier transform. Other transformations such as combinations or data, mathematical transforms, statistical analysis (e.g., one or more analyses through time and/or location), and the like can be used to determine features from the time series data. In some embodiments, correlations between time series data components, other features, and/or anomalies and the like can be stored in the system as features (e.g., similarity scores, correlation scores, etc. can be features). The features can be determined using the time series data, and therefore can represent time series data themselves. The raw time series data and/or the features can be used to determine anomalies or events. For example, various threshold analyses, multivariate models, machine learning models, or the like can be used with the time series data and/or features as inputs to provide an output that is indicative of the presence of absence of an anomaly or event.

Within this process, the time series data, features, information related to the features, and/or indications of anomalies or events can be presented to a user on an application interface Users can interact with the application interface and choose to view certain data on the application interface. As a user selects various information to display, the selections can be used as feedback to train a machine learning model. For example, the feedback can be used to train a model on a user's workflow, determine which features or events are related. Thus, the system can learn by recording the user feedback, which can be used with various models to identify and develop workflows, label training data sets, identify related time series data and/or features, and identify anomalies as well as solutions.

In addition, the models can consider all of the available features to determine which ones may be related. By observing the user feedback, the related features can be correlated and presented to a user either as a related feature or a recommendation for a related feature. Based on the continued user feedback, the system can learn which features are properly related and which features, even if appearing to be related, are not related in certain situations. As described herein, the system can make initial recommendations as users start to use the system, or the system can rely on user feedback to define the feature sets (e.g., related time series data, features, or the like). In these embodiments, the user feedback can be used as input along with the time series data and/or features to train a model to identify the time series data and/or features as members of a feature set. In some embodiments, the feedback can be used to label the input data (e.g., the time series data and/or the feature sets), and the labeled data can then be used to train the model(s). The model(s) can be trained over time or retrained as the user feedback is obtained, which may provide an up to date model as a plurality of users use the system over time.

The system can also be used to identify certain sets of features that can be used to identify specific anomalies or problems. Once a problem is identified, historical data on the actions taken by users can be identified and used to present common solutions to the problems. In some embodiments, the data can be used to predict various events such as anomalies, and potentially a time until such events occur. This can be used to provide predictive maintenance or solutions to prevent problems. The problems can be identified based on a machine learning model using the identified common features as input to thereby identify the specific problems and scenarios associated with the recommended solutions. In some embodiments, a range of solutions can be provided, and feedback provided based on the selected parameters can be used to narrow down the solutions based on the feedback. This can allow the system to learn and adapt over time to provide feedback to the users.

Within this system, the feedback provided by the users can serve to label the input data to provide an improved labeled data set for training the models used to identify anomalies, predict future anomalies, and/or provide solutions. For example, one or more problems can be identified based on a feature set and presented to a user. The user's selection of an identification of the problem and/or a solution to the problem can serve to identify the problem within the system by labeling the data associated with the presentation to the user. The corresponding time series data and/or features can then be labeled with the identified problem and used to retrain or update the machine learning model. This feedback cycle can then serve to provide an improved model used to identify problems and/or solutions for future identifications. This system can be used without any initial training and develop over time, which can allow the system to work across any time series data and environments. This can be useful in automating systems that have historically relied on manual user selections and identification of problems.

The methods and systems described herein can be used with a wide variety of sensor systems and environments. In general, the systems can be used with any field or programs that receive time series data. The system may be useful when a plurality of users (e.g., tens, hundreds, or even thousands of users) provide feedback on the time series data, and allow the feedback to be used to improve the systems. For example, hydrocarbon production facilities, pipelines, security settings, transportation systems, industrial processing facilities, chemical facilities, and the like can all use a variety of sensors or other devices that can produce time series data. Similarly, repair and maintenance facilities that use a variety of testing apparatus across many maintenance personnel can benefit from the system. Similarly, the health care industry that receives large volumes of data on patients (that can be anonymized in most situations) across many health care providers can also use the disclosed systems to identify diagnostic workflows, health diagnoses, and appropriate treatment options across the patient base. Many other industries and fields can also use the systems disclosed herein. The resulting data can be used in various processing systems, and the systems and methods as described herein can be used with those systems to provide additional insights on the workflows of the users and related features that may not be intuitively related to most, if any, users of the systems. In any of these fields, the systems described herein can be used along with existing identification systems and data analysis programs to learn the workflows, improve the identification of anomalies, and provide solutions and predictive services.

Overall, the system described herein allows for the interactions of a plurality of users with an application interface to be used to identify and isolate workflows or patterns based on user inputs and/or selections (e.g., any type of feedback), recommend selections for the user(s) based on prior input selections from the plurality of users using the same or similar workflows, and/or automatically drive or trigger correlations between selected time series data components or traces based on identified workflows. The system can also highlight anomalies or events that are relevant or related to isolated workflows through the correlation of the time series data to produce similarity scores between the selected and recommended time series data, features, or indications of an anomaly or event. The learned workflows can also allow the system to obtain feedback on the recommendations and iterate over the user base to learn from the user feedback to improve, relearn, or penalize the model outputs, thereby providing a self-learning capability to the workflow identification and development system. This type of system is distinct from those that simply observe the most commonly selected data components and recommend those items to a user.

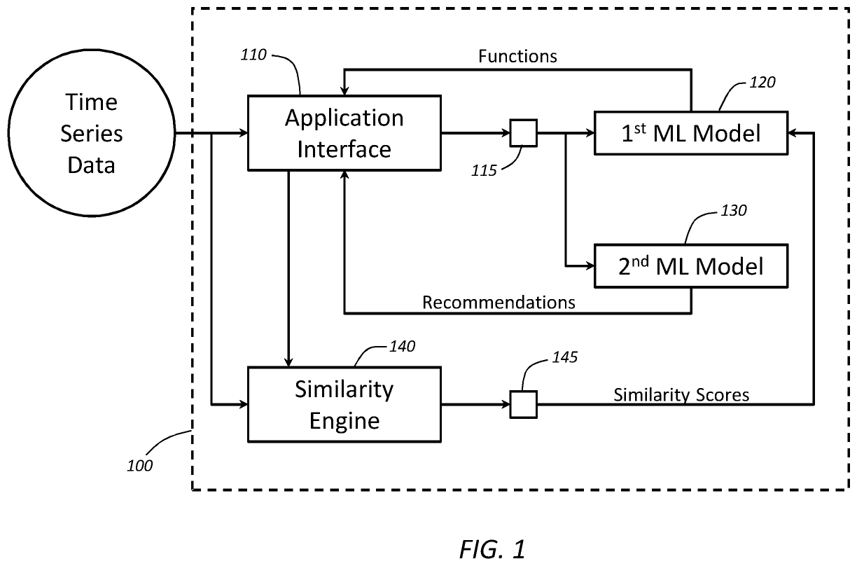

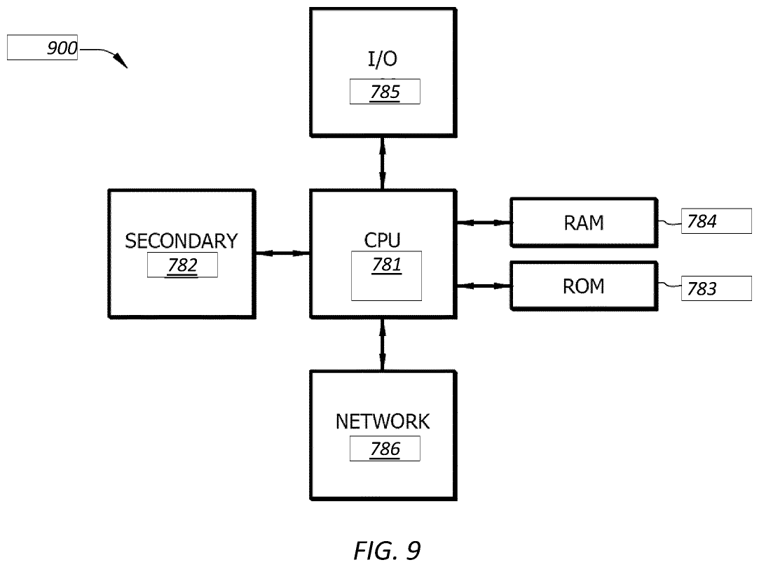

FIG. 1 is a schematic diagram of embodiments of a computer system 100 that can use one or more machine learning models to determine one or more workflows from time series data using feedback from an application interface 110. The components of the computer system 100 can be implemented on one or more computers or other devices comprising one or more processors, for example as described in FIG. 9. The components include one or more of an application interface 110, an optional machine learning label encoder 115, a first machine learning model 120, a second machine learning model 130, and a similarity engine 140.

Overall, the system 100 can be configured to receive time series data, optionally determine or extract one or more features based on the time series data using various functions or applications, present the one or more features and/or time series data, and learn a workflow of a user processing the one or more features and/or time series data. The system 100 can correlate information that is related based on user feedback and update the presentation of information over time to provide insights to the users operating the system. The system can then learn the workflows associated with specific events across many users, providing insights to the existing and future users of the system.

The system 100 can comprise an application interface 110. The application interface 110 can be configured to receive time series data (e.g., via a sensor signal received from one or more sensors shown in FIGS. 6A and 6B) and/or one or more features based on the received time series data. The features can be determined from the time series data using various devices, including one or more devices or computers that can determine the features prior to the features and/or time series data being provided to the system 100. In some embodiments, an anomaly detection engine can be used with the time series data and/or features to identify anomalies or events using one or more models such as one or more machine learning models. For example, a neural network may be used to predict one or more events from the features and/or time series data. Similarly, one or more multivariate models can be used with the time series data and/or features to identify the presence of one or more anomalies or events from the data. The anomaly detection engine can look at a plurality of the time series data components, features, and the correlations between the features to identify anomalies. This is distinct from using only thresholds or ranges, where an anomaly can be present based on combinations of time series data components and/or features even when individual elements may be within individual thresholds. As an example, an anomaly identified by a combination of pressure, temperature, and flow rate may be identified as an anomaly when the pressure and temperature are within their acceptable ranges (e.g., within alarm ranges, etc.) based on the flow rate being near, but within, a high or low flow rate limit. In other words, the combination of time series data components and/or feature may provide an anomaly detection envelope or volume having a dimension corresponding to the number of correlated time series data components and/or features. Thus, the present system can provide more accurate anomaly detection than relying solely on individual evaluation of the time series data components.

The resulting output of the models (e.g., an identification of the occurrence of an anomaly or event, an extent of the event, and the like) can be provided with the time series data and/or features to the system 100. In some embodiments, the data provided to the system 100 can then comprise time series data from one or more sensors, features derived from the time series data, and/or anomalies or events identified using one or more models with the time series data and/or features used as inputs. The one or more models may be separate from the system 100, and can, in some embodiments, represent existing models or software used in any of a variety of industries.

The one or more models can also provide an initial correlation of the time series data, features, and/or anomaly or event information that can be retained within the system. The correlation can be used to identify patterns within the data to indicate which elements of the data may be related. This information can then be used with the machine learning models in the system in association with the data being sent to the application interface 110.

The application interface 110 (and any application interface described in the embodiments herein) can be further configured to display a user interface on a display device (e.g., a phone, tablet, AR/VR device, laptop, etc.) for interpretation of the feature(s) by a user, such as an operations engineer of a chemical plant or wellbore environment, doctor, analyst, or the like. The user interface can be interactive with the user such that the user can make one or more selections regarding the time series, data, features, and/or indications of one or more anomalies or events displayed on the user interface, which can be used as feedback. The information can be available as various data traces, indicators, or the like, and can be selected from lists, drop down menus, manual selections, additional windows, or the like. For example, the user interface can display plant or wellbore data and inform the user via the application interface 110 of the time series data and/or features. The selections of the information by the user as well as actions taken with the information (e.g., scrolling over features, moving windows, aligning data traces, etc.) can be received by the application interface 110 as feedback, and the application interface 110 can then use the feedback in various ways. In some embodiments, the feedback can be used as input to the first machine learning model 120 and/or the second machine learning module 130. In some embodiments, the feedback can be used to label the data to provide training data for one or more of the machine learning models. In some embodiments, other forms of feedback such as the triggering of an alarm by a user can also be considered feedback.

In some embodiments, the selections or feedback can be weighted based on one or more factors such as an identity of the user, type of features, technology area, ratings per use, or the like. With a sufficient user base, a significant amount of feedback across many different types of events can be obtained. This type of information can represent a large knowledge base across the users, and the feedback can be weighted to provide account for differences in the information obtained from the users. For example, a higher weighting can be given to a more experienced user, and a lower weighting can be given to a less experienced user. For example, senior engineers may be given higher weightings than junior engineers using the system. As another example, certain technology areas may be more highly weighted than others. As still another example, the solutions provided by certain users may have better results than other uses. The users with the better results may be provided an identification associated with a higher weighting based on an overall results assessment than other users that have lower result assessments. This can help to weight the models by more heavily weighting the input by those users that can achieve better results. The weightings can be applied to the feedback when the feedback is provided to the first machine learning model 120 and/or the second machine learning model 130. The weightings can affect the training of the models to provide a more accurate output.

In some embodiments, before being received by the first machine learning model 120 and/or the second machine learning model 130, the feedback can first be encoded in the machine learning encoder 115. In the machine learning encoder 115, the feedback can be associated with one or more features, or labeled as associated to one or more functions of the system, via any technique for labeling in the context of machine learning. For example, the information can be converted to a standardized format, vector, matrix, or the like that can be used with the machine learning model(s). In this context, the feedback can be considered to be part of feedback received from the user through the application interface 110.

During use, the user may select various information based on the presentation of the information including the time series data, the features, and/or the indications of the anomalies or events. For example, an alarm or alert may be triggered by the time series data and/or features. In response, a user may select various time series data streams from certain sensors to try to diagnose the cause of the alarm or alert. The selections of the specific data streams can be considered feedback from the user. Further, the streams that are displayed together can also be correlated and considered as feedback for use by the system. Further, the specific order in which the time series data and/or features are displayed can be representative of a workflow when looking at the data. This workflow can be captured by using the selections and interactions of the user with the system as feedback for further analysis by the system. The set of time series data, features, and/or anomaly or event indicators, the order of presentation of the information, and/or the layout of information can be captured as a feature set that can define the workflow(s).

The first machine learning model 120 can accept inputs from the application interface 110 including information on the time series data, the features, the indications of an anomaly or event, the feedback, and/or any workflow information available. In some embodiments, the first machine learning model 120 can receive correlation information from one or more models operating on the time series data, features, and/or indications of the anomaly or event. The inputs of the feedback can be obtained directly from the application interface 110 and/or the machine learning encoder 115, which can provide the inputs in a form more easily usable by the first machine learning model 120. The first machine learning model 120 can process the inputs and determine an output including an identification of one or more features and/or time series data components that are related or correlated. This information can include an order of presentation of the features or time series data, which can be used to define a workflow for the user using the system 100.

The output of the first machine learning model 120 can then be used to recreate the workflows of the system and present the workflows upon the occurrence of specific events represented by one or more features. For example, when a user selects a certain time series data trace or a specific feature, the first machine learning model 120 can use the selection as an input to identify a specific workflow based on other time series data, features, or anomaly indicators, which may not be selected by the user. The workflow can define the additional information associated with the selected information, and the information can be suggested as potentially applicable. In some embodiments, the additional information associated with the workflow may be automatically displayed. The workflow can also comprise an order of presentation of the information, a layout of the information or the like, which can be provided to the user. As the workflow is presented, any feedback can be collected from the application interface. The resulting feedback can be used to retain or update the model as an input or through labeling of the data. For example, the feedback may indicate that a specific piece of information is not desired by the user, which may indicate that the model has selected an incorrect workflow based on the available information. The feedback can then be used to further refine the first machine learning model for future occurrences of the specific set of information.

In some embodiments, the workflow can be named or identified to provide one or more workflows available to a user on the application interface. For example, a list of available workflows learned within the system can be provided as a selection option, and the selection of a workflow can serve to present the information in the feature set defining the workflow can be presented on the application interface.

In some embodiments, the computer system 100 can be configured to train the first machine learning model 120 to determine a workflow that can be recommended in response to an occurrence of one or more of the time series data components, the features, and/or the indicators of an anomaly or event. The first machine learning model 120 can be trained using supervised or unsupervised learning techniques using the information obtained through the feedback in the system. The stream or sequence of functions in a workflow can be modified as the user provides more feedback over time (e.g., feedback signals) regarding the functions that they have viewed on the display device and made selections therefor. In some embodiments, the first machine learning model 120 can be retrained or updated with each received feedback signal. This can create a dynamic signal that can update the system while the user is using the system.

In some embodiments, the workflows as determined by the first machine learning model 120 can be based on outcomes or solutions associated with the workflows. Historical data can be used to train the first machine learning model, and the historical data can comprise at least some information on outcomes or actions associated with the feedback, features, and time series data.

In some embodiments, the training data can be weighted based on the outcomes or solutions associated with the data. The solutions may be defined by a series of steps or actions taken in response to the presentation of the features and/or time series data, including any recommendations or feature sets provided by the system. For example, outcome or solutions indicated as being successful can be weighted more heavily than those in which the solution is only partially successful or not successful at all (which may have a zero or small weighting factor). The outcomes or solutions can also be weighted at each step or action within the solution. For example, a step forming part of the solution that is determined to be incorrect (e.g., based on feedback or by the model) can be de-weighted (e.g., penalized) within the historical data that is used for training or updating of the model. This can help to reduce the likelihood that such a step in the solution is recommended by the system upon the occurrence of a similar feature set.

In embodiments, the first machine learning model 120 can include a deep neural network (DNN) model, a clustering model, a principal component analysis (PCA) model, a canonical correlation analysis (CCA) model, a supervised matrix factorization model, or a combination thereof. In some embodiments, more than one type of machine learning model may be employed as the first machine learning model 120. For example, a high-dimensional feature vector may be generated using a DNN model, and then the dimensionality of the vector may be lowered using another model. In some embodiments, workflows may be generated using a single machine learning model as the first machine learning model 120. For example, the first machine learning model 120 can have one or more inputs (time series data, features, selections, and optionally similarity scores explained below) and use a single ML model to obtain the output workflow.

In some other embodiments, multiple machine learning (ML) models can collectively define the first machine learning model 120. For example, in some embodiments one ML model of the first machine learning model 120 may be used to generate a first workflow vector based on selections received for a function, and a second ML model of the first machine learning model 120 may be used to generate a second workflow vector based on a similarity score received from the similarity engine 140. The workflow vectors obtained from the two ML models in the first machine learning model 120 may be aggregated (e.g., via concatenation, or using another machine learning model) and used for sending an output (e.g., a recommended workflow) to the application interface 110, which presents the output to a user via a user interface.

In some embodiments, the second machine learning model 130 can receive one or more selections from the application interface 110 as input, for example, via the machine learning encoder 115. In some embodiments, the selections received as input by the first machine learning model 120 and the selections received as input by the second machine learning model 130 are the same selections; alternatively, the application interface 110 and the machine learning encoder 115 can be configured to send a first set of selections as input to the first machine learning model 120 and a second set of selections as input to the second machine learning model 130, where the first and second sets do not include any of the same selections; alternatively, the application interface 110 and the machine learning encoder 115 can be configured to send a first set of selections as input to the first machine learning model 120 and a second set of selections as input to the second machine learning model 130, where the first and second sets have at least one selection in common.

The second machine learning model 130 can be configured to generate one or more recommendations for a time series data component, feature, or indicator of an anomaly as an output of the model based on the one or more selections that are received as input to the second machine learning model 130. As described herein, the features can be generated by functions or models within the system using the time series data, and indicators of anomalies or events can determined from the time series data and/or features. The recommendations can be for features generated by the system that are correlated to the current workflow obtained through feedback in the application interface. This can include features that correlate to those features and/or time series data components being displayed, even if the feedback has not requested the features and/or time series data components. The recommendations can represent insights into additional features or data that may be related but may not be apparent to a user as being related or part of a problem within the setting in which the time series data is being provided. Any of the recommendations generated as output by the second machine learning model 130 can be sent to the application interface 110.

In embodiments, the second machine learning model 130 can include a deep neural network (DNN) model, a clustering model, a principal component analysis (PCA) model, a canonical correlation analysis (CCA) model, a supervised matrix factorization model, or a combination thereof. In some embodiments, more than one type of machine learning model may be employed as the second machine learning model 130. For example, a high-dimensional feature vector may be generated using a DNN model, and then the dimensionality of the vector may be lowered using another model. In some embodiments, recommendations may be generated using a single machine learning model as the second machine learning model 130. For example, the second machine learning model 130 can have one or more inputs (selections, and optionally similarity scores explained below) and use a single ML model to obtain the output recommendation. In some other embodiments, recommendations may be generated using multiple machine learning (ML) models as the second machine learning model 130. For example, in some embodiments one ML model of the second machine learning model 130 may be used to generate a first recommendation vector based on selections received for a function, and a second ML model of the second machine learning model 130 may be used to generate a second recommendation vector based on a similarity score received from the similarity engine 140. The recommendation vectors obtained from the two ML models in the second machine learning model 130 may be aggregated (e.g., via concatenation, using another machine learning model, etc.) and used for sending the one or more recommendations to the application interface 110, which presents the one or more recommendations to a user via a user interface.

In some embodiments, the computer system 100 can be configured to train the second machine learning model 130 using selections received from the application interface 110. The second machine learning model 130 can be trained using supervised or unsupervised learning techniques. The computer system 100 can be further configured to identify, using the second machine learning model 130, one or more additional features, time series data components, and/or functions to be included in the any of the recommendations generated by the second machine learning model 130.

The similarity engine 140 can be configured to provide information to the first machine learning model 140 regarding similarity of time series data 101 and/or features based on the time series data 101 that is received by the similarity engine 140. In some embodiments, the similarity engine 140 can be configured to identify, using one or more functions, one or more features (e.g., an event, an anomaly, etc. in the time series data) derived from the time series data (e.g., time series data received by the computer system from a sensor signal). The similarity engine 140 can additionally be configured to determine a similarity score between multiple features in the time series data. The similarity score can be a measure of any correlation between the features. For example, a correlation metric, autocorrelation feature, or other comparison can be performed with respect to the features and/or time series data components to determine which features and/or time series data components are related. In embodiments, the similarity engine 140 can include a simple binary classifier, a machine learning model, or the like, and the similarly score can be a binary score (e.g., related or not related), or a rating of the degree of relation between identified features and/or time series data components. The similarly engine 140 can then output the similarly score to the first machine learning model 120 for use as an input.

In some embodiments, the first machine learning model 120 and/or the second machine learning model 130 can additionally use one or more similarity scores that are optionally associated with one or more of the features based on the time series data (e.g., by machine learning encoder 145). In the machine learning encoder 145, the similarity scores can be associated with one or more features, or labeled as associated to one or more features via any technique for labeling in the context of machine learning.

The similarity engine 140 can include a logistic regression model and/or a support vector machine (SVM) model, for example. Any of a number of different approaches may be taken with respect to logistic regression. For example, in at least one embodiment, a Bayesian analysis may be performed, with pairwise item preferences derived from the time series data; alternatively, a frequentist rather than a Bayesian analysis may be used.

As an example of a use of the system described with respect to FIG. 1, a maintenance facility can comprise a number of diagnostic tools and sensors that can be used to diagnose various types of equipment. The system 100 can be used to learn a workflow associated with a diagnostic process. The information from the diagnostic tools and sensors can be time series data that can be provided to the system. Various features and indicators of anomalies can be determined by existing diagnostic systems and provided with the time series data to the system. The information can then be available for presentation on an application interface. As a maintenance engineer reviews the data, the set of steps and actions taken can be recorded as feedback. For example, an engineer working on a turbine may monitor a vibration sensor, temperature sensor, and speed sensor to diagnose a misbalance in the turbine. As additional time series data is reviewed such as a torque sensor, the feedback can be recorded within the system. The final set of time series data traces can then be recorded within the system, including the order of the selection of the time series data, the layout of the information, and the like. Within the system, the similarity engine may examine the available data to determine which time series data may be related. The feedback, the similarity scores, and the workflow can then be provided to the first machine learning model as training data.

In a subsequent maintenance process, a user trying to diagnose a turbine may start with a vibration sensor. Based on a correlation within the system between the vibration sensor, the torque sensor data, and speed sensor data, the first machine learning model may predict the presence of a maintenance issue as previously identified by a past user. The system can then suggest or present additional information associated with the speed sensor and torque sensor data as being useful to the user based on the learned workflow. The machine learning model may also predict the problem and suggest the problem and a solution. Any feedback received as part of the workflow presentation can be used to verify that the specific data and/or features are related such that the feedback can be used to label the data and update the training data to include the new information. The model can then be refined based on the new labeled data in addition to the original training data. The system can then learn and present the workflows as well as updating the system to self-learn and update the data used with the system.

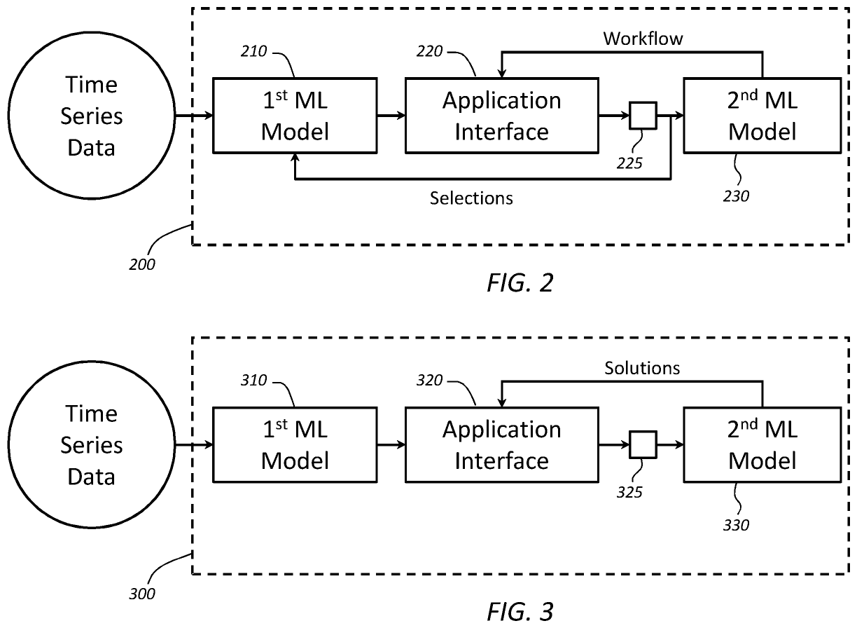

FIG. 2 is a schematic diagram of an embodiment of a computer system 200 that uses machine learning models that can present or recommend time series data, features, and/or indications of anomalies. The components of the computer system 200 can be implemented on a computer or other device comprising a processor, such as the systems as described in FIG. 9. The components can include one or more of a first machine learning model 210, an application interface 220, a machine learning label encoder 225, and a second machine learning model 230.

The computer system 200 can be configured to receive time series data (e.g., via a sensor signal received from one or more sensors shown in FIGS. 6A and 6B), execute a first machine learning model 210, and identify, using the first machine learning model 210, one or more features and/or indicators or an anomaly or event (e.g., events, anomalies, process states, etc.) in the time series data. The first machine learning model 210 can be configured to send an identification of the one or more features in the time series data to the application interface 220. Within the first machine learning model, one or more models or functions can operate to determine the features from the time series data. The functions can comprise machine learning models, signature based event identification models, threshold indications, correlations, or the like. The functions in the first machine learning model 210 can be trained using historical data and/or test data. In some embodiments, first principles models can be used to identify one or more features within the time series data as part of the first machine learning model 210.

As an example, various sensors can be associated with a wellbore to allow for monitoring of the wellbore during production of hydrocarbon fluids to the surface. Sensors can include temperature sensors, pressure sensors, vibration sensors, and the like. In some embodiments, the temperature sensor can comprise a distributed temperature sensor (DTS) that uses a fiber optic cable to detect a distributed temperature signal along the length of the wellbore. Similarly, a distributed acoustic sensor (DAS) that uses a fiber optic cable to detect a distributed acoustic signal along the length of the wellbore can also be used. Additional sensors can also be present in the wellbore and at the surface (e.g., flow sensors, fluid phase sensors, etc.). The output of the sensors can be provided to the first machine learning model 210 as a time series data stream. Within the first machine learning model 210, one or more functions or models can be performed to derive features such as statistical features from the time series data. The time series data can be pre-processed using various techniques such as denoising, filtering, and/or transformations to provide data that can be processed to provide the features. In this example, one or more frequency domain features can be obtained from the DAS acoustic data, and one or more temperature features (e.g., statistical features through time and/or depth) can be obtained from the DTS data. The features can be used in various models to determine one or more features within the wellbore such as one or more event identifications. For example, the DAS and/or DTS data can be used to determine the presence of fluid flowing into the wellbore, determine fluid phase discrimination within the wellbore, detect fluid leaks, detect the presence of sand ingress, and the like. The features can be used to determine anomalies or events using functions or models. Thus, the features used as inputs to the first machine learning model 210 can be used to provide an output comprising an identification of the one or more anomalies or events within the wellbore as an example.

The application interface 220 can be configured to generate an indication and present the indication of the one or more features and/or anomalies to a user interface for viewing by a user. In addition to the features, the application interface 220 can also present one or more components of the time series data along with the indication of the features. The presentation of the features and/or time series data components can be used by a user to monitor the process, identify and diagnose problems within the process, and/or identify if solutions are producing the desired effects.

The application interface 220 can be configured to present information and accept feedback by the user. When viewed by a user, the application interface 220 can receive feedback in the form of one or more selections from the user interface, motion of a selection on the application interface, an order of the selection of the information, an organization of the information on the interface, or the like and send the feedback to the second machine learning model 230. As noted above, the feedback can be weighted in some embodiments based on a characteristics or identification of a user (e.g., a user role, seniority, etc.) such that certain feedback can be weighted differently than others. In some embodiments, the feedback can first be encoded in the machine learning encoder 225. In the machine learning encoder 225, the feedback can be associated with one or more features (e.g., received from the application interface 220 along with the feedback) and/or one or more functions (e.g., received from the application interface 220 along with selections), or labeled as associated to one or more features and/or to one or more functions via any technique for labeling in the context of machine learning.

As an example, the application interface 220 can present an indication of one or more events occurring within a wellbore based on the time series data obtained and used by the first machine learning model. In some embodiments, various events can include fluid inflow events (e.g., including fluid inflow detection, fluid inflow location determination, fluid inflow quantification, fluid inflow discrimination, etc.), fluid outflow detection (e.g., fluid outflow detection, fluid outflow quantification), fluid phase segregation, fluid flow discrimination within a conduit, well integrity monitoring, including in-well leak detection (e.g., downhole casing and tubing leak detection, leaking fluid phase identification, etc.), flow assurance (e.g., wax deposition), annular fluid flow diagnosis, overburden monitoring, fluid flow detection behind a casing, fluid induced hydraulic fracture detection in the overburden (e.g., micro-seismic events, etc.), sand detection (e.g., sand ingress, sand flows, etc.). One or more components of the time series data can also be presented along with the features. For example, pressure readings within the wellbore can be displaced along with an indication of sand ingress at one or more locations along the wellbore on a wellbore schematic. A user can view the features and select additional information to be added to the application interface, remove some features and/or components of the time series data, and/or request entirely different features or time series data to be viewed. Each selection of the data can be recorded as feedback by the application interface 220. For example, if a specific temperature feature is selected for viewing along a sand ingress log and pressure readings, the feedback can include the selection of the temperature feature as well as an indication that the selected temperature feature can be related or correlated with the sand ingress event identifications and the pressure readings. The machine learning encode 225 can then optionally encode the information for use with the second machine learning model 230.

As another example, the application interface 220 can present an indication of one or more diagnoses associated with one or more patients using the first machine learning model. Various time series information such as a medical history, lab results, biometric measurements (e.g., temperature, heart rate, blood pressure, etc.) can be used as an input into the first machine learning model, and the model can provide a diagnosis based on the inputs. The information for the patient or patients can be displayed on an application interface along with the diagnosis or recommendations for potential diagnoses. A physician can then view the information along with the identified diagnoses, and the physician can provide feedback by selecting a desired patient information to view and/or select a diagnosis for further review. The feedback can then be used to correlate the related feature sets. Depending on the selected diagnosis, the information related to the diagnosis can be correlated to the time series data and/or features in the feature set, and the machine learning model can be updated or retrained using the new data. In this sense, the selection of the diagnosis by the physician can serve to reinforce the values of the information being related to the diagnosis.

Returning to FIG. 2, the second machine learning model 230 can be configured to receive the one or more selections or feedback from the application interface 220. The computer system 200 can train, using the received selections, the second machine learning model 230 to determine one or more additional features, additional time series data components, indications of an anomaly or event, and/or sub-features (e.g., anomaly features) associated with the one or more features and/or time series data components provided by the application interface. The second machine learning model 230 can send the one or more sub-features associated with one or more features to the application interface 220, and the application interface 220 can be configured to present the sub-features of the features to a user interface for view by a user. The additional features can also be presented as suggestions or recommendations for display on the application interface 220. For example, a recommendation can be provided to the application interface 220 to indicate to a user that an identified feature may be related to the features and/or time series data components being viewed. The additional feedback obtained based on the recommendation can be used as further input into the second machine learning model 230.

In some embodiments, the second machine learning model 230 can also determine feature sets, which can represent features and/or time series data components that are related. The feature sets can be determined using similarity scores and/or using first principles models. The second machine learning model 230 can initially base feature sets using the similarity scores and/or the first principle models and identify the features as being related. The features within the feature sets can be used in presenting or recommending additional features as part of the output of the second machine learning model 230. The feedback can then be used to verify that the features within the feature sets are related. For example, if a feature is identified as being part of a feature set and is presented or recommended for viewing on the application interface, but the feedback consistently indicates that the feature is not related to the other features in the feature set, the second machine learning model 230 can determine that the feature is not part of the feature set. Additional features can also be identified as being part of a feature set based on user feedback even if the initial similarity scores and/or first principles models do not identify the feature as part of a feature set. Depending on the amount of data in the time series data, a plurality of feature sets can be identified within the time series data and/or the features obtained based on the time series data. Any given feature can be part of one or more feature sets identified by the system.

Using the wellbore environment as an example, features including events and measurements within the wellbore (e.g., time series data components such as a time series pressure or temperature reading) can be determined from the time series data provided by the sensors such as the DAS and DTS sensors within or associated with the wellbore. The features can include a set of features, some of which can represent anomalies or events and some which may not. The features can be determined for a range of possible events, and those features that are related to an event can be grouped as being related to each other, thereby forming a feature set. When one or more features of the feature set are being displayed, the remaining features or information about the event can also be displayed. For example, if one or more frequency domain features obtained from the acoustic signal are used to determine the presence of sand ingress at a location within the wellbore, one or more additional features such as other frequency domain features, a pressure signal, and/or a temperature feature can also be determined to be part of the feature set and displayed or recommended for display on the application interface 220. If a feature such as a temperature feature is displayed and feedback from the user closes the display, this can be seen as an indication to the second machine learning model 230 that the identified temperature feature may not be properly part of the feature set.

In some embodiments, the second machine learning model 230 can be configured to receive the information from the application interface 220 (e.g., via encoder 225). For example, the second machine learning model 230 can receive an indication of the features and/or time series data components being displayed, the feedback, an order in which the data is requested, specific data being viewed, and the like. The second machine learning model 230 can additionally determine a workflow, where the workflow defines a set of features and/or time series data components being viewed and/or instructions being selected or provided through the system. The second machine learning model 230 can provide an output to the application interface to learn the workflows and update the information provided to the application interface to match the workflows.

In some embodiments, the first machine learning model 210 can be configured to receive feedback from the application interface 220, optionally associated with one or more features and/or one or more time series data components by the machine learning encoder 225. The first machine learning model 210 can be configured to update itself using the received selections and identify, using the updated first machine learning model 210 a second set of features of the time series data (e.g., a second anomaly).

Embodiments of the first machine learning model 210 and/or the second machine learning model 230 can independently include a deep neural network (DNN) model, a principal component analysis (PCA) model, a canonical correlation analysis (CCA) model, a supervised matrix factorization model, or a combination thereof. In some embodiments, the first machine learning model 210 and/or the second machine learning model 230 can comprise multivariate models that are trained using a labeled data set as described herein. The first machine learning model 210 and/or the second machine learning model 230 can be trained using supervised or unsupervised learning techniques.

In some embodiments, features based on the time series data may be generated using a single machine learning model as the first machine learning model 210. For example, the first machine learning model 210 can have one or more input (time series data, features, and optionally selections from the application interface 220) and use a single ML model to obtain the output features. In other embodiments, multiple machine learning (ML) models can collectively define the first machine learning model 210. For example, in some embodiments one ML model of the first machine learning model 210 may be used to generate a first feature vector based on time series data that is received, and a second ML model of the first machine learning model 210 may be used to generate a second feature vector based on selections received from the application interface 220. The feature vectors obtained from the two ML models in the first machine learning model 210 may be aggregated (e.g., via concatenation, or using another machine learning model) and used for sending the output (e.g., the one or more features) to the application interface 220, which presents the output to a user via a user interface.

In some embodiments, sub-features or workflows may be generated using a single machine learning model as the second machine learning model 230. For example, the second machine learning model 230 can have one input (selections) and use a single ML model to obtain the output workflow or output sub-features that are sent to the application interface 220.

Continuing with the wellbore example, the ability of the system to provide indications of additional features, time series data components, and/or workflows can allow insights into the occurrence of features or events within the wellbore. By automatically monitoring which features are related, additional events or the cause of events can be identified. The additional features can be provided as a display or recommendation to help additional users recognize common problems within the wellbore. For example, features that may not intuitively be linked to an event in the wellbore can be identified as being correlated and presented to a user. Across multiple users and uses of the system, the system can learn which features are related and provide recommendations for various features related to certain events identified from the time series data.

As another example, the application interface 220 can present an indication of one or more diagnoses associated with one or more patients using the first machine learning model. Various time series information such as a medical history, lab results, biometric measurements (e.g., temperature, heart rate, blood pressure, etc.) can be used as an input into the first machine learning model, and the model can provide a diagnosis based on the inputs. The information for the patient or patients can be displayed on an application interface along with the diagnosis or recommendations for a diagnosis. A physician can then view the information along with the identified diagnoses, and the physician can provide feedback by selecting a desired patient information to view and/or select a diagnosis for further review. The feedback can then be used to correlate the related feature sets. Depending on the selected diagnosis, the information related to the diagnosis can be correlated to the time series data and/or features in the feature set, and the machine learning model can be updated or retrained using the new data. In this sense, the selection of the diagnosis by the physician can serve to reinforce the values of the information being related to the diagnosis.

The systems as described herein can also be used to identify solutions based on identifying common feature sets, using those features to identify specific events or problems, and then using the data to identify solutions common to the identified events or problems from known data. In some embodiments, the systems can be used to provide predictive behaviors, which can allow for a prediction of the time to an occurrence. FIG. 3 is a schematic diagram of embodiments of a computer system 300 that utilizes machine learning models to present a solution that is associated with features (e.g., events, anomalies, etc.). The components of the computer system 300 can be implemented on a computer or other device comprising a processor, for example as described in FIG. 9. The components include one or more of a first machine learning model 310, an application interface 320, a machine learning label encoder 325, and a second machine learning model 330.

The computer system 300 can be configured to receive time series data (e.g., via a sensor signal received from one or more sensors shown in FIGS. 6A and 6B), and the computer system 300 can be further configured to use the first machine learning model 310 to identify one or more features and/or indications or an anomaly or event in the time series data and send/present/recommend the one or more features on the application interface 320. In some embodiments, the only input to the first machine learning model 310 may be the time series data, features, and/or a representation thereof. The application interface 320 can be configured to present the one or more time series data components and/or features to a user via the application interface and to receive selections, arrangements, and the like from the user via the application interface (e.g., feedback, etc.). The computer system 300 can be configured to receive the feedback from the application interface 320 based on the first machine learning model 310 presenting the one or more features on the application interface 320, where each selection provides an indication of an identification of one or more of the features. The second machine learning model 330 can be configured to identify a corresponding feature that corresponds to the one or more features identified by the first machine learning model 310. In some embodiments, the second machine learning model 330 can then identify a solution that is associated with the corresponding feature and present the solution to the application interface 320. In some embodiments of the solution identification, the first machine learning model 310 may only receive time series data as input (and does not receive selections from the application interface 320 as inputs).

In some embodiments, the second machine learning model 330 can provide a predictive analysis to indicate a time until an anomaly or event occurs. This can allow for the identification of a solution to prevent the anomaly or event from occurring. As an example, the second machine learning model 330 may provide an indication of a time to failure for a piece of rotating equipment. The time to failure can allow for a predicative maintenance schedule to be implemented to extend the life of the equipment and delay the time to the failure of the equipment. In this example, the solution provided by the second machine learning model 330 can comprise an action taken to prevent or delay the occurrence of the predicted anomaly or event.

The application interface 320 can send the selections to the second machine learning model 330. In some embodiments, the selections can first be encoded in the machine learning encoder 325. In the machine learning encoder 325, the selections can be associated with one or more features (e.g., received from the application interface 320 along with the selections) and/or one or more solutions (e.g., generated by the second machine learning model 330), or labeled as associated to one or more features and/or to one or more solutions via any technique for labeling in the context of machine learning.

Embodiments of the first machine learning model 310 and the second machine learning model 330 can independently include a deep neural network (DNN) model, a principal component analysis (PCA) model, a canonical correlation analysis (CCA) model, a supervised matrix factorization model, one or more multivariate models, or a combination thereof.

In some embodiments, features may be generated using a single machine learning model as the first machine learning model 310. For example, the first machine learning model 310 can have one input (time series data) and use a single ML model to obtain the output features.

In some embodiments, the solution may be generated using a single machine learning model as the second machine learning model 330. For example, the second machine learning model 320 can have one input (selections) and use a single ML model to obtain the output workflow or output sub-features that are sent to the application interface 320.

As an example in the oilfield context, the time series data can comprise data from one or more sensors within a wellbore, which can include DAS acoustic data and/or DTS based temperature data. The time series data can be provided to the first machine learning model 310 to determine the presence of one or more events or anomalies within the wellbore. The resulting event identifications can be provided to the application interface along with one or more time series data components. Based on the feedback from a user through the application interface 320, the presence of the event can be confirmed as well as any associated features within the time series data. The resulting feedback can be passed to the second machine learning model 330. For example, an identification of sand ingress along with associated time series data such as pressure readings, flow rates, and the like can be provided as inputs to the second machine learning model. The second machine learning model can then use the set of features and events to identify similar occurrences in historical data. For example, a feature set can be identified along with past occurrences involving the feature set. The historical data can then be examined to identify actions taken based on the same or similar set of features. The resulting actions can then be recommended or presented on the application interface. For example, a cause of the sand ingress can be provided to the application interface. Multiple solutions may be possible simply based on one of the features or events, and the remaining features can be used to identify the closest solution. For example, an identified sand ingress at a given location may be caused by a first cause when a correlated pressure reading is within a first range, and correlated to a second cause when the pressure reading is within a second range or rate of change. The system and the second machine learning model may consider all of the related features in finding the solution to the problem, thereby improving diagnostic workflows as well as providing improved resolutions or work plans for correcting any issues with the wellbore.

As another example in the transportation context, the time series data can comprise data from one or more sensors associated with a train, which can include acoustic data, temperature sensors, location sensors, or the like. The time series data can be provided to the first machine learning model 310 to determine the presence of one or more events or anomalies associated with the train, such as the status of the wheel bearings. The resulting event identifications can be provided to the application interface along with one or more time series data components. For example, the acoustic data associated with the wheel bearings can be displayed along with one or more temperature sensors. Based on the feedback from a user through the application interface 320, the presence of an event such as an anticipated wheel bearing failure can be confirmed as well as any associated features within the time series data. The resulting feedback can be passed to the second machine learning model 330. For example, an identification of the anticipated wheel bearing failure along with associated time series data such as the corresponding acoustic data and/or temperature data and the like can be provided as inputs to the second machine learning model. The second machine learning model can then use the set of features and events to identify similar occurrences in historical data. For example, a feature set can be identified along with past occurrences involving the feature set. The historical data can then be examined to identify a prediction of the time to failure for the wheel bearing based on the same or similar set of features. The model can then provide an estimate of the time to failure along with potential maintenance or other actions that could extend the time to failure. The resulting actions can then be recommended or presented on the application interface. Multiple solutions (e.g., multiple options for maintenance, repairs, etc.) may be possible simply based on one of the features or events, and the remaining features can be used to identify the closest solution. For example, an identified wheel bearing failure at a given location may be caused by a first cause when a correlated acoustic reading is within a first range, and correlated to a second cause when the acoustic reading is within a second range or rate of change. The system and the second machine learning model may consider all of the related features in finding the solution and/or predictive maintenance schedule for the wheel bearing failure, thereby improving diagnostic workflows as well as providing improved resolutions or work plans for correcting any issues with the train.

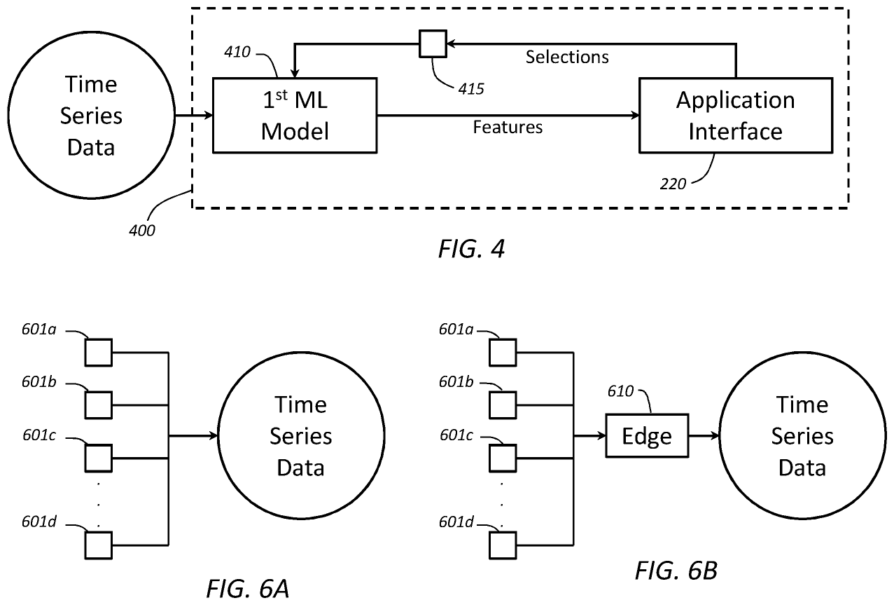

FIG. 4 is a schematic diagram of embodiments of the disclosed computer system 400 that utilizes machine learning models to identify features in time series data and train the machine learning models using feedback from an application interface. The components of the computer system 400 can be implemented on a computer or other device comprising a processor as described in FIG. 9. The components include one or more of a machine learning model 410, an application interface 420, and a machine learning label encoder 425.

The machine learning model 410 can be configured to receive time series data (e.g., via a sensor signal received from one or more sensors shown in FIGS. 6A and 6B) as input and determine one or more features (e.g., events, anomalies, etc.) in the time series data as the output. The machine learning model 410 can send one or more of the determined features to the application interface 420, which is configured to present one or more of the features and/or time series data components to a user via a user interface. The application interface 420 can be configured to receive selections from the user interface, and can send/present the selections to the machine learning model 410 as a second input for the first machine learning model 410. The machine learning model 410 can be configured to receive the selection(s) from the application interface 420, wherein each selection provides an indication of an identification of one or more of the features.

As is the case for any machine learning model disclosed herein, the first machine learning model 410 can be trained using training data. The training data can comprise a set of time series data that is used for training the model. In some embodiments, historical data on features obtained from the time series data, optionally along with historical selections and feedback, can be used to train the first machine learning model 410. Over time, the machine learning model 410 can be re-trained or updated using the received selection(s), and the re-trained machine learning model 410 can then re-identify one or more features in subsequent time series data that is received by the machine learning model 410. For example, the historical data set can be updated over time based on the newly received features, time series data, and selections. The updated historical data can then be used to update (e.g., re-train, adjust, etc.) the first machine learning model to take into account the new information. The updating of the first machine learning model can take place after each set of feedback occurs, periodically at defined intervals, or upon any other suitable trigger or triggering event. The updated historical data can be labeled data and include both the features, any identified feature sets, one or more time series data components, and potential outcomes, results, or solutions associated with the features and time series data.

The application interface 420 can receive one or more selections from the user interface and send the selections to the machine learning model 410. In some embodiments, the selections can first be encoded in the machine learning encoder 415. In the machine learning encoder 415, the selections can be associated with one or more features (e.g., received from the application interface 410 along with the selections), or labeled as associated to one or more features via any technique for labeling in the context of machine learning.

Embodiments of the machine learning model 410 can include a deep neural network (DNN) model, a clustering model a principal component analysis (PCA) model, a canonical correlation analysis (CCA) model, a supervised matrix factorization model, one or more multivariate models, or a combination thereof. In some embodiments, features may be generated using a single machine learning model as the machine learning model 410. For example, the machine learning model 410 can use a single ML model to obtain the output features.

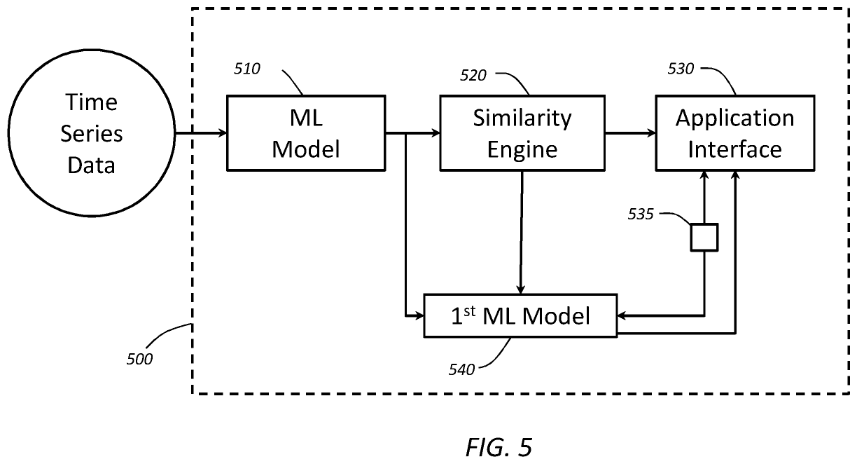

FIG. 5 is a schematic diagram of embodiments of the disclosed computer system 500 that utilizes machine learning models to determine features are related to one another. The components of the computer system 500 can be implemented on a computer or other device comprising a processor, for example as described in FIG. 9. The components include one or more of a first machine learning model 510, a similarity engine 520, an application interface 530, a machine learning label encoder 535, and a second machine learning model 540.

The first machine learning model 510 received the time series data (e.g., any of the sensor signals described herein) as input and can be configured to determine one or more features in the time series data. The first machine learning model 510 can be configured to send the features to a similarity engine 520, which is configured to determine similarity scores between two or more of the features received from the first machine learning model 510.

The similarity engine 520 can be configured to send the similarity scores to the application interface 530, which is configured to present information related to at least a first feature of the features to a user interface for view by a user of the computer system 500. The similarity engine 520 can include a logistic regression model and/or a support vector machine (SVM) model, for example. Any of a number of different approaches may be taken with respect to logistic regression. For example, in at least one embodiment, a Bayesian analysis may be performed, with pairwise item preferences derived from the time series data; alternatively, a frequentist rather than a Bayesian analysis may be used.

The application interface 530 can be configured to receive feedback on the information via the application interface 530 from the user. The application interface 530 can be configured to send the feedback to the second machine learning model 540, and the similarity engine 520 is configured to send similarity scores to the second machine learning model 540. The second machine learning model 540 is configured to determine information related to at least a second feature of the features using the feedback and the similarity scores. The second machine learning model 540 can then be configured to send information related to the first feature and information related to the second feature to the application interface 530. In some embodiments, the second machine learning model 540 can use reinforcement learning to update the information related to the features to provide the outputs from the model. The application interface 530 can be configured to present the information to a user via the application interface, and the feedback loop (iterations of the described process) can be repeated where feedback is received from the user at the application interface 530 and sent to the second machine learning model 540. As described herein, the selections or feedback can be optionally weighted based on any available identity of the user. For example, a higher weighting can be given to a more experienced user, and a lower weighting can be given to a less experienced user. For example, senior engineers may be given higher weightings than junior engineers using the system.

The initial set of feedback may or may not include information related to the first feature or second feature for which the second machine learning model 540 generates. Thus, unless one or more criteria for terminating feedback have been met, the next feedback iteration may begin upon receipt of each feedback from the application interface. The termination criteria may, for example, include input from the user that no further information is to be presented and/or the use of the system is terminated. In a given feedback loop (e.g., iteration), a set of one or more feedback signals may be collected and interpreted by the application interface 530. Depending on the size of the set of feedback signals, the feedback signals may be collected and/or interpreted even before the features have been identified as the first and second features.

The application interface 530 can receive feedback from the user interface and send the feedback to the second machine learning model 540. In some embodiments, the feedback can first be encoded in the machine learning encoder 535. In the machine learning encoder 535, the feedback can be associated with one or more similarity scores (e.g., received from the application interface 530 along with the feedback), or labeled as associated to one or more similarity scores via any technique for labeling in the context of machine learning.

Embodiments of the first machine learning model 510 can include a deep neural network (DNN) model, a clustering model, a principal component analysis (PCA) model, a canonical correlation analysis (CCA) model, a supervised matrix factorization model, one or more multivariate models, or a combination thereof. In some embodiments, features may be generated using a single machine learning model as the first machine learning model 510. For example, the first machine learning model 510 can have one input (time series data) and use a single ML model to obtain the output features.

Embodiments of the second machine learning model 510 can include a deep neural network (DNN) model, a clustering model a principal component analysis (PCA) model, a canonical correlation analysis (CCA) model, a supervised matrix factorization model, or a combination thereof. In some embodiments, information related to the first and second features may be generated using a single machine learning model as the second machine learning model 540. For example, the second machine learning model 540 can have one input (time series data) and use a single ML model to obtain the output features. In other embodiments, multiple machine learning (ML) models can collectively define the second machine learning model 540. For example, in some embodiments one ML model of the second machine learning model 540 may be used to generate a first feature information vector based on one of i) feedback, ii) similarity scores, or iii) features that is received, and a second ML model of the second machine learning model 540 may be used to generate a second feature information vector based on one of i) feedback, ii) similarity scores, or iii) features. Yet in some other embodiments, one ML model of the second machine learning model 540 may be used to generate a first feature information vector based on feedback, a second ML model of the second machine learning model 540 may be used to generate a second feature information vector based on similarity scores, and a third LM model of the second machine learning model 540 can be used to generated a third feature information vector based on features. The multiple feature information vectors obtained from the two or three ML models in the second machine learning model 540 may be aggregated (e.g., via concatenation, or using another machine learning model) and used for sending the output (e.g., the information related to the first and second features) to the application interface 540, which presents the output to a user via a user interface.

In some embodiments, the second machine learning model 540 can be configured to cluster the information related to the first feature and information related to the second feature for form clustered information. The second machine learning model 540 can send the clustered information, in addition to the unclustered information or in lieu of the unclustered information, to the application interface 530. The application interface 530 can present the clustered information to a user via the user interface. In some embodiments, the clustered information is presented when the first feature or the second feature are determined in the time series data by the first machine learning model 510.

In some embodiments, the feedback comprises a selection of information related to the second feature. In some embodiments, determining the features in the time series data comprises using the first machine learning model 510 to detect one or more downhole events in the time series data.

In all of the above-described embodiments, the application interfaces 110/220/320/420/530 can include an interactive interface configured to receive one or more inputs, wherein the one or more inputs comprise at least one of: a selection of an item, a gesture, or a deselection of an item.

As shown in FIGS. 6A and 6B, sensors 601a-n can be any sensor that measures a parameter with respect to time, such as pressure transducers, temperature sensors (e.g., thermocouples, DTS based temperature sensors, etc.), gas analyzers, acoustic sensors (e.g., DAS based sensors), optical sensors, downhole sensors, flow sensors, etc. The sensors can provide the time series data directly to any of the systems provided herein as shown in FIG. 6A. In some embodiments, an edge based computing system 610 can be used at or near the location of the sensors. The edge computing device can be configured to process the time series data to provide a format that can be sent to the computing systems as described herein. Depending on the level of sophistication of the edge computing device 610, one or more features can be determined in the edge computing device 610. For example, a machine learning model used to identify one or more events can be executed in the edge computing device 610, and an identification of the events can then be sent to the systems as described herein. The edge computing device 610 can help to control the data load being transferred from the sensors to the systems, which can be helpful when the systems are executing remotely from the sensors themselves.

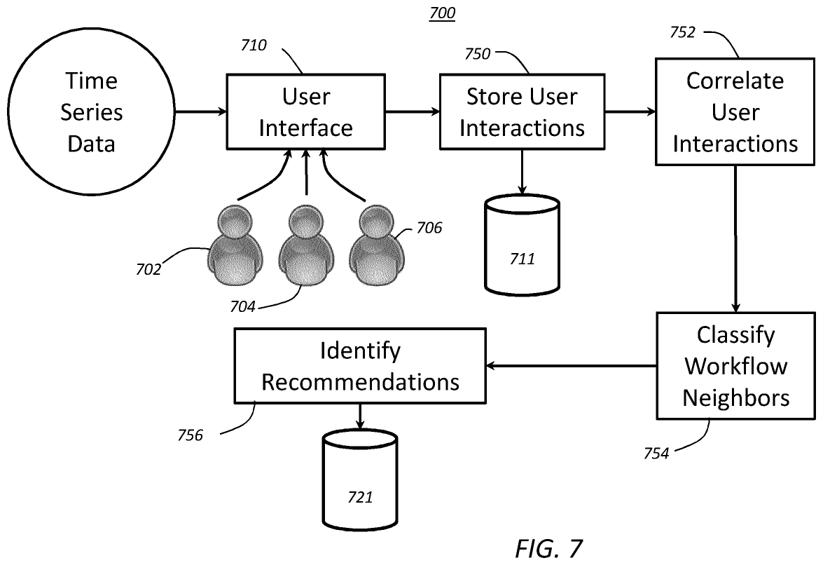

Additional aspects are shown in FIG. 7. FIG. 7 illustrates a schematic flow of a method for embedding a workflow capture in an analysis system. The method 700 can be used to encode knowledge of the workflows and parameters used in one or more workflows for use in additional processing systems. In some aspects, the method 700 can use one or more of the systems or components of the systems described herein. For example, the method 700 can be carried out using the system as described with respect to FIG. 1 in some aspects. Other suitable systems can also be used.

As shown in FIG. 7, the method 700 can begin with a plurality of users 702, 704, 706 interacting with a user interface, and the user interactions can be stored in a database 711 in step 750. The user interface 710 can be the same or similar to the user interface 110 of FIG. 1. During use, the users 702, 704, 706 can interact with the user interface 710 and select one or time series data and/or features to view. Each user 702, 704, 706 can select different time series data and/or features as part of their workflows. The user queries and/or selections can be tracked using the user interface 710. As described in more detail herein, the workflows can also be captured. For example, the order of the selection of the time series data and/or features can also be tracked by the user interface 710, and data for each user of the plurality of users 702, 704, 706 can also be tracked and stored. In some aspects, the time series data and/or feature interaction taxonomy can be stored. The tracked information can then be stored in a memory or database 711.

In some aspects, the metadata associated with the time series data and/or features can be tracked by the user interface 710. Metadata can represent information about the time series data and/or features but not include the actual measurement or feature values. For example, metadata for the time series data and/or features can include an identification of the type of data, type of sensor, location of the sensor, and/or selection criteria or parameters without include the actual sensor or feature values. Metadata for features that include combinations of time series data and/or events or anomalies identified from time series data can include the same types of information such as the type of feature, an identification of the underlying data used to determine the feature, a location of the feature or event, or the like. For example, time series data including temperature data can include metadata indicating that the data is temperature data, the type of temperature sensor used, a location of the temperature sensor, or the like, but may not include the actual temperature readings. The use of metadata for the time series data and/or features may help to reduce the amount of data processed by the system as part of the knowledge encoder process. For example, storing metadata identifying the type of time series data used by a user allows for a single value or a significantly reduced set of values to be stored in relation to a user session relative to the total amount of data viewed by the user during the session.

As an example, the first user 702 can select three time series data components including sensor data for temperature sensor readings, accelerometer readings, and pressure sensor readings. The second user 704 can select four time series data components including sensor data for temperature sensor readings, velocity sensor readings, pressure sensor readings, and motor current sensor readings. The third user 706 can select four time series data components including sensor data for oil quality sensor readings, particulate quality sensor readings, viscosity sensor readings, and temperature sensor readings. This information can then be tracked in the user interface 710 based on each user requesting the information. The metadata associated with the sensor calls can then be tracked and stored in the database 711.

In step 752, the user interactions and workflows can be correlated to identify similarities between the interactions of different users 702, 704, 706. In some aspects, the correlations can include similarity scores, correlation scores, and the like. The correlations can be used on explicit correlations and/or implicit correlations. Explicit correlations refer to a correlation between the same types of time series data and/or features. For example, both the first user 702 and the second user 704 select temperature sensor data. As a result, there is an explicit correlation between the first user's 702 sensor calls and the second user's 704 sensor calls with respect to the temperature data.

In some aspects, the explicit correlations can be used on metadata associated with the users' interactions, where positive explicit correlations can be determined when one or more elements of metadata match between sensor data calls across user interactions, workflows, or analyses. This can include any of the metadata associated with the interactions, time series data calls, and/or feature calls, even when different types of metadata are associated with each user interaction. For example, the metadata for temperature sensor data can include an indicator that the time series data is temperature data, an indicator of the type of sensor used, a location of the sensor, etc. Even if the type of sensor and the location of the temperature sensor are different between users, the explicit correlation can include a finding that at least one elements of the metadata aligns between the user interactions. In the example, even if the temperature sensors are of different types, the reference by multiple users to temperature data as the type of data can result in a positive correlation between the two user interactions.

The correlations can also be based on implicit correlations. Implicit correlations refer to sensor data that measures the same or a similar feature of the data and/or physical property based on different types of sensors. The implicit correlations can indicate if the user interactions represent the same type of data even when different sensor information is used. Initially, a correlation table or cross-reference can be used to identify the physical phenomenon or properties associated with each sensor type, or alternatively the types of sensor data associated with each type of physical phenomena. In some aspects, various combinations or derivatives of sensor data can be used to determine data for different physical phenomena. In some aspects, implicit correlations can be used on portions of the metadata such as different data having the same units of measure. The correlation can then include determining if time series data and/or features from different sensor data represents or aligns with the same or similar data for the user.

The implicit correlations can be based on metadata associated with the time series data and/or features. The metadata can be used to identify the information for the time series data and/or features associated with the user interactions. The implicit correlations can be determined by determining if one or more elements of metadata associated with a first user's interactions or sensor data calls represent or are used to identify the same or a similar physical phenomenon as one or more elements of metadata associated with a second user's interactions or sensor data calls. A lookup table, model, or other correlation process can be used in the implicit correlation step to provide a degree of matching (e.g., a correlations core, a similarity score, or the like). Since implicit correlations may be found without a direct matching of the metadata, such correlation or similarity score may be ranked lower than an explicit correlation between the users' interactions, time series data, and/or feature calls.

In some aspects, the correlations can be quantified using a variety of models. The resulting correlation or similarity scores can be compared to a similarity score threshold or thresholds to determine if the correlations represent the same or similar workflows, as described in more detail below. In some aspects, the correlation or similarity scores can be determined using normalized correlation ratings based on a number of implicit and explicit correlations between pairs of users. For example, when there are four sensor calls, a match (e.g., an explicit or implicit correlation) of three of the four sensor calls could result in a correlation score of 0.75. Other correlation scoring can be used such as the use of Pearson's coefficient based collaborative filtering to provide similarity ratings based on the implicit and explicit correlations. This process can include computing pairwise correlation between implicit and explicit scores of each user using rows with no missing values. The resulting correlated workflows can be stored in the workflow neighbor database 721. The user interactions that are not correlated can also be stored for comparison with other user interactions.

Continuing the example from above, the workflows between each of the users 702, 704, 706 can be determined. Considering the first user 702 and the second user 704, both users 702, 704 created data calls for temperature and pressure sensor data as part of their interactions during their working sessions. Based on the calls for the same types of data for these sensors, there is an explicit correlation between the first user and the second user. In addition to the explicit correlation, the first user 702 also called for accelerometer data, and the second user 704 called for velocity sensor data. Since both an accelerometer and velocity sensor can be used to detect similar phenomenon such as movement, vibration, and/or position, there is an implicit correlation between a third set of time series data between the first user 702 and the second user 704. As a result of correlating all three sensors calls from the first user 702 to the sensors calls for the second user 704, there is a strong correlation between the workflows of the first user 702 and the second user 704.

The first user's 702 interactions and workflow can be correlated with the third user's 706 interactions and workflow. Both the first user 702 and the third user 706 have calls for temperature sensor data. This represents an explicit correlation for this time series data between the users. However, the third user 706 did not have any explicit or implicit correlations for the accelerometer or pressure sensor data as called by the first user 702, and the first user 702 did not have any explicit or implicit correlations for the particulate quality sensor data, viscosity sensor data, or the oil quality sensor data as called by the third user 706. As a result, the correlation or similarity score between the first user 702 and the third user 706 may have a low value or ranking. Similarly, the second user 704 and the third user 706 both called for temperature data, which represents an explicit correlation between the time series data for temperature sensor data. However, none of the other time series data or features are explicitly or implicitly correlated between the second user 704 and the third user 706. As a result, the correlation or similarity score between the second user 704 and the third user 706 may have a low value or ranking.

Once the user interactions and workflows are correlated to identify the similarities, the resulting correlation or similarity scores can be used to classify the workflows and establish clusters or workflow neighbors (where workflow neighbors can represent a workflow having a cluster of time series data calls, features, or the like) at step 754. The correlation process can result in the correlation or similarity scores, and the resulting correlation or similarity scores can be compared to one or more thresholds to identify which workflow correlations are similar enough to identify as being related. In some aspects, various correlation models or methods can be used to help to identify which workflows have a sufficient correlation or similarity score using a variety of factors (e.g., explicit and implicit correlations, number of interactions, pattern of interactions, etc.). When a workflow is identified between users as being a workflow cluster or neighbor, the resulting workflow and the data associated with the time series data and/or features can be stored in a workflow neighbor database 721. In some aspects, the workflow neighbor classification can be based on metadata associated with time series data, features, or a workflow rather than the data, feature, or information itself.

The process noted above can be repeated as a plurality of users continue to use the system. In some aspects, the process can be carried out to correlate user data calls with other user data calls and/or workflow neighbors in the workflow neighbor database 721. Across a plurality of users, a set of workflow neighbors can be identified along with the associated data calls and/or metadata associated with the data calls. Various workflows can then be identified and used within an organization. Any of the considerations used with respect to the identified workflows as described herein can be used with the workflow neighbors. For example, the information from certain users can be weighted more heavily than other users, the identified workflows can be used to make recommendations for additional data calls, and the like.

As the users 702, 704, 706 interact with the system, one or more workflow neighbors may be identified and classified over time, and the resulting workflow neighbors can be stored in the database 721 and used to identify additional recommendations for information for users interacting with the system at step 756. In this step, a user may start to interact with the system and call one or more time series data and/or features. As each call is made, the user queries are tracked using the user interface 710, and the user calls can be compared against the time series data and/or features within defined workflow neighbors. In some aspects, the metadata associated with the user queries can be used in the correlation with the workflow neighbors to identify related or similar workflows within the neighbor workflow database.

When a correlated workflow neighbor is identified using the correlation process as described herein, the data calls associated with the other time series data and/or features within the workflow neighbors can be recommended to a user. In some aspects, the metadata associated with the workflow neighbors for the time series data and/or features that has not been called by a user can be supplied to the system. The system can then use the metadata to identify corresponding time series data and/or features to recommend to a user. Any of the processes to present and display recommended time series data and/or features as described herein can be used with the user interface 710 to present additional information associated with the workflow neighbor.

When presented, the user can select to view the recommended time series data and/or features, or the user can dismiss or ignore the recommendation. When the user elects to view the time series data and/or features, the information can be displayed on the user interface 710, and the correlation or similarity score for the time series data and/or features can be increased within the workflow neighbor group. Conversely, if the user dismisses or ignores the recommendation, the correlation or similarity score for the time series data and/or features can be decreased within the workflow neighbor group. This allows feedback in the form of user interactions to further strengthen the correlation or similarity scores to help define the workflow neighbor definitions. Once the correlation and similarity scores are updated, they can be stored in the workflow neighbor database 721.

Continuing with the example from above, if a user were to interact with the system and request time series data associated with a temperature sensor and an accelerometer, the system can correlated the sensor data to a workflow neighbor that includes temperature sensor data, accelerometer or velocity meter data, and pressure sensor data. Once the workflow neighbor is correlated (e.g., after the selection of the temperature and accelerometer sensor data), the system can recommend displaying pressure sensor data, and potentially velocity sensor data, to the user. This allows the user to take advantage of workflows identified based on the interaction of a plurality of users with the system. While the example described herein only includes data from three to four sensors, in practice the number of data calls and the amount and types of sensor data can be less than or greater than (and in some instances much greater than) data from three to four sensors or sensor types. Further, the use of metadata in tracking the user interactions can serve to limit the amount of information processed by the system, and thereby allow the process to occur in real time or near real time.

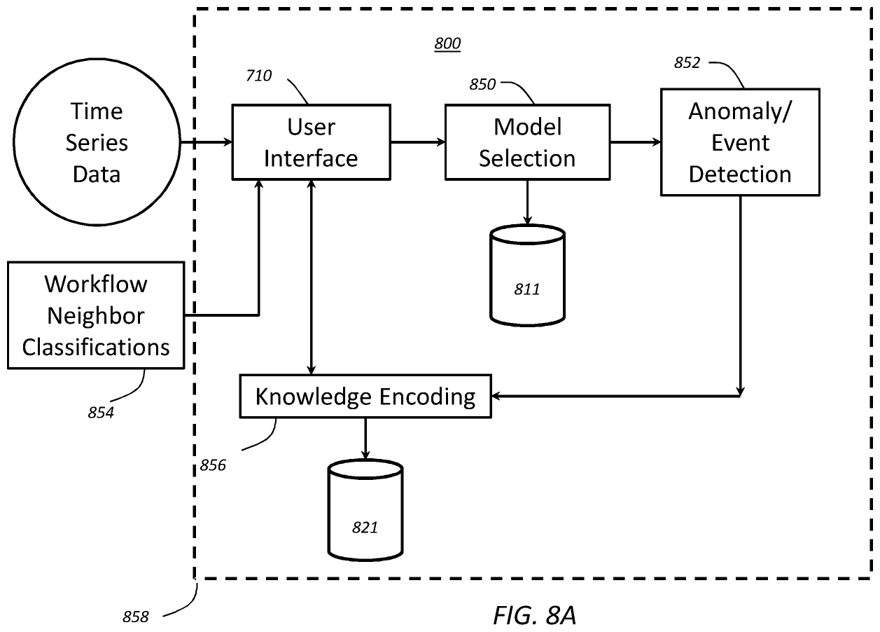

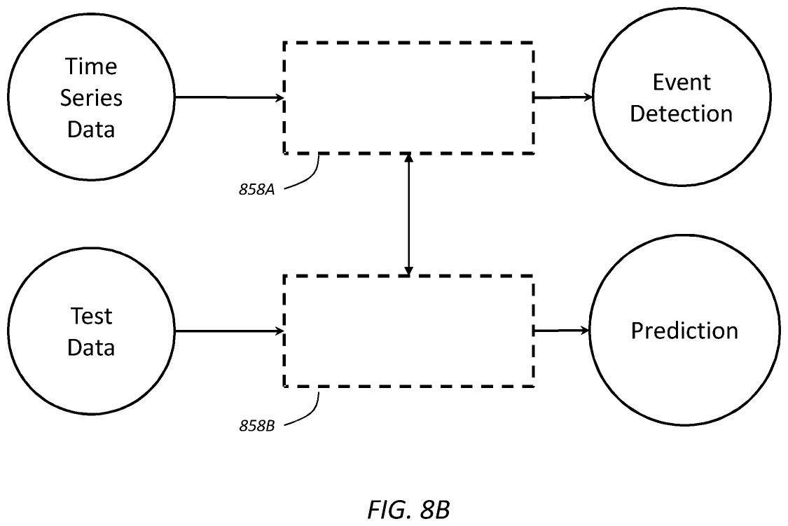

Once the system described with respect to FIG. 7 is implemented, the workflow neighbors can be used as part of a knowledge graphing and generation process within the system. FIG. 8 illustrates a schematic flow of a method for workflow capture in an analysis system. The method 800 can be used to identify anomalies and/or events as well as encoding knowledge of the workflows and parameters used in one or more workflows for use in additional processing systems. In some aspects, the method 800 can use one or more of the systems or components of the systems described herein. For example, the method 800 can be carried out using the system as described with respect to FIG. 1 in some aspects, and use the elements developed with respect to FIG. 7 in some aspects. Other suitable systems can also be used.

As shown in FIG. 8, the method 800 can begin with a plurality of users 8 interacting with a user interface 710. In addition to the interactions with users, the user interface can be in signal communication with the time series data source, a source (e.g., a database, etc.) of workflow neighbor classifications 854, and optionally a source of encoded knowledge such as a knowledge graph. The user interface 710 can be the same or similar to the user interface 710 of FIG. 7. During use, the users can interact with the user interface 710 and select one or time series data and/or features to view. Each user of the plurality of users can select different time series data and/or features as part of their workflows. The plurality of selections can be received on the user interface and identify a plurality of time series data elements and/or features.

As described with respect to FIG. 7, the plurality of selections can be correlated with a plurality of workflows, where each workflow of the plurality of workflows can define a set of associated time series data elements in addition to other elements in some aspects. The time series data can originate with or be derived using any of the data sources described herein. For example, the time series data elements can be received from a plurality of sensors, a plurality of edge devices, or a combination thereof. Based on the plurality of selections from the users, a first workflow of the plurality of workflows can be identified. For example, the plurality of selections can be used with the workflow neighbor classifications 854, which can comprise the plurality of workflows that are identified, to identify at least a first workflow. As more workflows are identified over time, the new workflows can be stored in the workflow neighbor classifications 854 and accessed based on the plurality of selections.

Once the first workflow is identified, a first set of time series data elements that are associated with the first workflow can be retrieved. In some aspects, each workflow can comprise metadata associated with or identifying the time series data elements and/or features associated with the workflow neighbors. The metadata can be used to call the associated time series data elements and/or features. In some aspects, the workflow can track the first set of time series data elements and display the first set of time series data elements and/or features once the first workflow is identified.

In some aspects, a model selection step 850 can be optionally carried out. In the model selection process, the user selections, any identified workflow neighbors, the corresponding time series data and/or features, and optionally any known relationships as identified by the knowledge encoding 856 step can be passed to the model selection step. In some aspects, a plurality of models can be associated with the system, which can be stored in storage 811. Based on the data passed to the model selection step, one or more models associated with the time series data elements and/or features, the workflow neighbors, and/or the encoded knowledge can be identified. In some aspects, each workflow may be associated with a single model such as a single event for a process, which can be selected based on the identified workflow passed to the model selection step. In some aspects, a plurality of models may be associated with a workflow. For example, a workflow for diagnosing a bearing on a vehicle may be associated with models for bearing failures, overheating, and lubricant leaks in order to identify potentially multiple problems with the bearing based on the bearing diagnostic workflow. In this aspect, a plurality of models associated with one or more workflows can be retrieved from the model storage 811. When one or more models are selected in the model selection step 850, any data relied upon by the one or more model can be obtained for use with the model. The data may already be passed to the model selection step, or a separate request to the time series data source can be made to retrieve and/or determine the appropriate time series data elements and/or features.

Once the first set of time series data elements and/or features are retrieved by the system, an event can be identified at step 752 using an anomaly detection process and/or event detection as described herein. In some aspects, the one or more models selected at the model selection step 850 can be used in the anomaly or event detection step 852 to identify if an anomaly or event exists based on the time series data identified by the workflow. Within this process, the models, anomalies, and or events can be displayed on the user interface 710, and user feedback can be generated as described herein. The resulting feedback can be used to identify if the appropriate workflow is selected by the system and if the event exists. The feedback can then be used to automatically update the system as described herein.

When anomaly detection is used, the first set of time series data elements can be used to develop a baseline for the first set of time series data. The baseline can be based on one or more of the time series data elements and/or features, and in some aspects, the baseline can be a multivariable envelope or multidimensional volume defining the anomaly detection. When the first set of time series data elements and/or features are obtained at a second time period, the resulting values can be used with the anomaly detection to determine if an anomaly exists.

In some aspects, the feedback can be used to identify new workflows and/or associated workflows together. As an example, the initial plurality of time series data elements retrieved based on the workflow identification can cause the system to retrieve and receive a second plurality of time series data elements and/or features. The second plurality of time series data elements can comprise the plurality of time series data elements obtained based on identifying the first workflow (e.g., the plurality of time series data elements can be a subset of the second plurality of time series data elements). The larger selection of the second plurality of time series data elements ca then be displayed or provided to the user interface 710. Upon receiving user feedback, a selection of a time series data elements not within the first time series data elements an be used as an indication that the additional time series data element and/or feature is related or associated with the first workflow. Similarly, a failure to select another time series data element or feature can indicate that the first set of time series data elements and/or features was correct and that the additional elements displayed are not related to or associated with the first workflow. In the way, if a data element associated with the first workflow is not initially selected by the user, the display of the additional elements as part of the workflow can be used to obtain feedback on whether or not the additional elements are related as provided by the feedback Across many users, this process can be used to tune the selection of time series data elements and/or features within an identified workflow.

In some aspects, the selection process can be repeated with additional time series data selections. For example, a user can provide a second plurality of selections related to a second plurality of time series data. A second workflow can be identified based on a correlation between the plurality of selections and the plurality of workflows. A second set of time series data elements can then be retrieved, and a second event can be identified based on the second set of time series data elements. This process can be repeated across any number of time series data requests and workflows, and the larger the number of users and use of the system, the larger that the number of workflows can be. Within the plurality of workflows, the various time series data elements can overlap to any degree. When the time series data elements and/or feature match exactly between workflows, it can indicate that a plurality of models can be associated with the corresponding workflow.

Within the system using the workflows and feedback to update and tune the system, an optional knowledge encoding engine 856 can be used to encode the knowledge, for example, using a knowledge graph to store the corresponding information. In this process, the queries obtained from the users on the user interface 710 can be correlated between two or more uses as described herein. When the user queries across the users are determined to be correlated, the resulting queries can be identified as related, for example as determining a workflow as described herein. A knowledge graph can then be generated based on the correlation of the queries. A knowledge graph can generally define or contain facts and relationships. In some aspects, the time series data elements can represent facts, and the correlations between the time series data elements such as the correlations can represent relationships between the facts. In some aspects, the workflows can represent the relationships between time series data identified as being correlated between the workflows. The resulting knowledge graphs and/or relationships can be stored in the knowledge store 821. In some aspects, the resulting knowledge encoding can be used with the initial workflow selection process as part of the process 800.

Within the process 800, the various elements and processes can be used with models to identify and represent the system producing the time series data elements. For example, the various models and knowledge encoding can be used to identify events and provide information on the system being monitored by various sensors that produce the time series data. The overall system and processes 858 can then be seen as a way of representing the system being monitored. As events arise, the system 858 can then be used to identify events occurring or predictable based on time series data.

As shown in FIG. 8B, the use of the system 858 to actively monitor a system or process using any of the embodiments disclosed herein can be used to provide a digital twin for testing, evaluation, and prediction. Within these embodiments, the time series data can be the same and/or originate from any of the same sources as described herein. Based on the time series data passing to the systems 858A as disclosed herein that can utilize feedback and inputs to train the various models, an output providing event identification and/or other information on the system. The system 858A can then be duplicated as a digital twin 858B. In general, a digital twin is a digital representation of an actual system or process. In some aspects, the digital twin 858B can be obtained based on the modeling and feedback mechanisms as described herein. The two systems 858A and 858B can be linked so that as the actual data, models, and feedback occurring within the main system 858A are updated, they can be similarly updated and copied over to the digital twin 858B. The two systems may then be essentially the same with regard to the models, knowledge encoding, and output formats.

The digital twin 858B then allows for different data to be input into the system 858B. The test data can mirror time series data, but may not represent actual data from the process being monitored. The test data can then be used to identify the effects of various changes in the system. This may allow for predictions based on certain inputs using the test data. For example, the test data can represent the time series data with changes intended to improve efficiency in the system. The predictions can then be used to identify potential outputs of the system and/or events resulting from the changes. Similarly, the test data can be used to represent upset or emergency conditions and predict potential outcomes from those conditions. In other aspects, the test data can be used with data at other locations to help identify any deficiencies in the models within the digital twin 858B. The digital twin can then be used in any of the technologies or areas as described herein.

Any of the systems and methods disclosed herein can be carried out on a computer or other device comprising a processor. FIG. 9 illustrates a computer system 900 suitable for implementing one or more embodiments disclosed herein such as the acquisition device or any portion thereof. The computer system 900 includes a processor 782 (which may be referred to as a central processor unit or CPU) that is in communication with memory devices including secondary storage 784, read only memory (ROM) 786, random access memory (RAM) 788, input/output (I/O) devices 790, and network connectivity devices 792. The processor 782 may be implemented as one or more CPU chips.

It is understood that by programming and/or loading executable instructions onto the computer system 900, at least one of the CPU 782, the RAM 788, and the ROM 786 are changed, transforming the computer system 900 in part into a particular machine or apparatus having the novel functionality taught by the present disclosure. It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an application specific integrated circuit (ASIC), because for large production runs the hardware implementation may be less expensive than the software implementation. Often a design may be developed and tested in a software form and later transformed, by well-known design rules, to an equivalent hardware implementation in an application specific integrated circuit that hardwires the instructions of the software. In the same manner as a machine controlled by a new ASIC is a particular machine or apparatus, likewise a computer that has been programmed and/or loaded with executable instructions may be viewed as a particular machine or apparatus.

Additionally, after the system 900 is turned on or booted, the CPU 782 may execute a computer program or application. For example, the CPU 782 may execute software or firmware stored in the ROM 786 or stored in the RAM 788. In some cases, on boot and/or when the application is initiated, the CPU 782 may copy the application or portions of the application from the secondary storage 784 to the RAM 788 or to memory space within the CPU 782 itself, and the CPU 782 may then execute instructions that the application is comprised of. In some cases, the CPU 782 may copy the application or portions of the application from memory accessed via the network connectivity devices 792 or via the I/O devices 790 to the RAM 788 or to memory space within the CPU 782, and the CPU 782 may then execute instructions that the application is comprised of. During execution, an application may load instructions into the CPU 782, for example load some of the instructions of the application into a cache of the CPU 782. In some contexts, an application that is executed may be said to configure the CPU 782 to do something, e.g., to configure the CPU 782 to perform the function or functions promoted by the subject application. When the CPU 782 is configured in this way by the application, the CPU 782 becomes a specific purpose computer or a specific purpose machine.

The secondary storage 784 is typically comprised of one or more disk drives or tape drives and is used for non-volatile storage of data and as an over-flow data storage device if RAM 788 is not large enough to hold all working data. Secondary storage 784 may be used to store programs which are loaded into RAM 788 when such programs are selected for execution. The ROM 786 is used to store instructions and perhaps data which are read during program execution. ROM 786 is a non-volatile memory device which typically has a small memory capacity relative to the larger memory capacity of secondary storage 784. The RAM 788 is used to store volatile data and perhaps to store instructions. Access to both ROM 786 and RAM 788 is typically faster than to secondary storage 784. The secondary storage 784, the RAM 788, and/or the ROM 786 may be referred to in some contexts as computer readable storage media and/or non-transitory computer readable media.

I/O) devices 790 may include printers, video monitors, liquid crystal displays (LCDs), touch screen displays, keyboards, keypads, switches, dials, mice, track balls, voice recognizers, card readers, paper tape readers, or other well-known input devices.

The network connectivity devices 792 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other well-known network devices. These network connectivity devices 792 may enable the processor 782 to communicate with the Internet or one or more intranets. With such a network connection, it is contemplated that the processor 782 might receive information from the network, or might output information to the network (e.g., to an event database) in the course of performing the above-described method steps. Such information, which is often represented as a sequence of instructions to be executed using processor 782, may be received from and outputted to the network, for example, in the form of a computer data signal embodied in a carrier wave.

Such information, which may include data or instructions to be executed using processor 782 for example, may be received from and outputted to the network, for example, in the form of a computer data baseband signal or signal embodied in a carrier wave. The baseband signal or signal embedded in the carrier wave, or other types of signals currently used or hereafter developed, may be generated according to several methods well-known to one skilled in the art. The baseband signal and/or signal embedded in the carrier wave may be referred to in some contexts as a transitory signal.

The processor 782 executes instructions, codes, computer programs, scripts which it accesses from hard disk, floppy disk, optical disk (these various disk based systems may all be considered secondary storage 784), flash drive, ROM 786, RAM 788, or the network connectivity devices 792. While only one processor 782 is shown, multiple processors may be present. Thus, while instructions may be discussed as executed by a processor, the instructions may be executed simultaneously, serially, or otherwise executed by one or multiple processors. Instructions, codes, computer programs, scripts, and/or data that may be accessed from the secondary storage 784, for example, hard drives, floppy disks, optical disks, and/or other device, the ROM 786, and/or the RAM 788 may be referred to in some contexts as non-transitory instructions and/or non-transitory information.

In an embodiment, the computer system 900 may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the computer system 900 to provide the functionality of a number of servers that is not directly bound to the number of computers in the computer system 900. For example, virtualization software may provide twenty virtual servers on four physical computers. In an embodiment, the functionality disclosed above may be provided by executing the application and/or applications in a cloud computing environment Cloud computing may comprise providing computing services via a network connection using dynamically scalable computing resources. Cloud computing may be supported, at least in part, by virtualization software. A cloud computing environment may be established by an enterprise and/or may be hired on an as-needed basis from a third party provider. Some cloud computing environments may comprise cloud computing resources owned and operated by the enterprise as well as cloud computing resources hired and/or leased from a third party provider.

In an embodiment, some or all of the functionality disclosed above may be provided as a computer program product. The computer program product may comprise one or more computer readable storage medium having computer usable program code embodied therein to implement the functionality disclosed above. The computer program product may comprise data structures, executable instructions, and other computer usable program code. The computer program product may be embodied in removable computer storage media and/or non-removable computer storage media. The removable computer readable storage medium may comprise, without limitation, a paper tape, a magnetic tape, magnetic disk, an optical disk, a solid state memory chip, for example analog magnetic tape, compact disk read only memory (CD-ROM) disks, floppy disks, jump drives, digital cards, multimedia cards, and others. The computer program product may be suitable for loading, by the computer system 900, at least portions of the contents of the computer program product to the secondary storage 784, to the ROM 786, to the RAM 788, and/or to other non-volatile memory and volatile memory of the computer system 900. The processor 782 may process the executable instructions and/or data structures in part by directly accessing the computer program product, for example by reading from a CD-ROM disk inserted into a disk drive peripheral of the computer system 900. Alternatively, the processor 782 may process the executable instructions and/or data structures by remotely accessing the computer program product, for example by downloading the executable instructions and/or data structures from a remote server through the network connectivity devices 792. The computer program product may comprise instructions that promote the loading and/or copying of data, data structures, files, and/or executable instructions to the secondary storage 784, to the ROM 786, to the RAM 788, and/or to other non-volatile memory and volatile memory of the computer system 900.

In some contexts, the secondary storage 784, the ROM 786, and the RAM 788 may be referred to as a non-transitory computer readable medium or a computer readable storage media. A dynamic RAM embodiment of the RAM 788, likewise, may be referred to as a non-transitory computer readable medium in that while the dynamic RAM receives electrical power and is operated in accordance with its design, for example during a period of time during which the computer system 900 is turned on and operational, the dynamic RAM stores information that is written to it. Similarly, the processor 782 may comprise an internal RAM, an internal ROM, a cache memory, and/or other internal non-transitory storage blocks, sections, or components that may be referred to in some contexts as non-transitory computer readable media or computer readable storage media.

Having described various systems and methods, certain aspects can include, but are not limited to:
In a first aspect, a method of workflow selection and event detection comprises receiving, on a user interface, a plurality of selections from a user, wherein the plurality of selections identifies a plurality of time series data elements; correlating the plurality of selections with a plurality of workflows, wherein each workflow of the plurality of workflows defines a set of associated time series data elements; identifying a first workflow of the plurality of workflows associated with the plurality of selections; retrieving a first set of time series data elements associated with the first workflow; and identifying an event using the first set of time series data elements.
A second aspect can include the method of the first aspect, wherein the plurality of time series data elements is received from a plurality of sensors, a plurality of edge devices, or a combination thereof.
A third aspect can include the method of the first or second aspect, wherein each workflow of the plurality of workflows is associated with an event for a process.
A fourth aspect can include the method of the third aspect, wherein each workflow is associated with at least one detection model for the event associated with a corresponding workflow.
A fifth aspect can include the method of any one of the first to fourth aspects, further comprising: receiving, by a processor, a second plurality of time series data elements, wherein the plurality of time series data elements is a subset of the second plurality of time series data elements; and providing, by the processor on the user interface, a selection of the second plurality of time series data elements to the user, wherein the plurality of selections is chosen from the selection of the second plurality of time series data elements.
A sixth aspect can include the method of any one of the first to fifth aspects, further comprising: presenting, on the user interface, at least one time series data element within the first set of time series data elements associated with the first workflow not within the plurality of selections from the user; receiving, on the user interface, a selection of the at least one time series data element by the user, wherein the selection indicates that the at least one time series data element is related to the plurality of selections.
A seventh aspect can include the method of the sixth aspect, wherein the identifying of the first workflow is based on the selection of the at least one time series data element by the user.
An eighth aspect can include the method of any one of the first to seventh aspects, further comprising: receiving, on the user interface, a second plurality of selections, wherein the second plurality of selections identifies a second plurality of time series data elements; correlating the second plurality of selections with the plurality of workflows; identifying a second workflow of the plurality of workflows associated with the second plurality of selections; retrieving a second set of time series data elements associated with the second workflow; and identifying a second event using the second set of time series data elements.
A ninth aspect can include the method of the eighth aspect, wherein at least one time series data element is the same in both the plurality of time series data elements and the second plurality of time series data elements.
A tenth aspect can include the method of the eighth or ninth aspect, wherein event and the second event are different events
An eleventh aspect can include the method of any one of the first to tenth aspects, further comprising: determining, using the first set of time series data elements at a first time, a baseline for the first set of time series data elements; determining, using the first set of time series data elements at a second time, that the first set of time series data elements exceed the baseline, wherein detecting the event is based on the first set of time series data elements exceeding the baseline.
A twelfth aspect can include the method of the eleventh aspect, further comprising: providing, on the user interface, an indication the first set of time series data elements associated with the first workflow exceed the baseline; receiving, on the user interface, feedback on the indication; and updating the baseline based on the feedback.
A thirteenth aspect can include the method of any one of the first to twelfth aspects, wherein the first workflow is associated with a first learning model, and wherein detecting the event comprises: inputting the first set of time series data elements into the first learning model;
receiving an output from the first learning model; and detecting the event using the output from the first learning model.
A fourteenth aspect can include the method of any one of the first to thirteenth aspects, wherein each workflow of the plurality of workflows is associated with a learning model.
A fifteenth aspect can include the method of any one of the first to fourteenth aspects, further comprising: generating a second plurality of time series data elements, wherein the second plurality of time series data elements comprise at least one test data set; using the first workflow with the second plurality of time series data elements, and identifying a second event using the first workflow with the second plurality of time series data elements.
A sixteenth aspect can include the method of any one of the first to fifteenth aspects, further comprising: using at least one of the plurality of workflows as a digital twin.
In a seventeenth aspect, a system comprises: a memory storing a workflow application; and a processor, wherein the workflow application, when executed on the process, configures the processor to: receive, on a user interface, a plurality of selections from a user, wherein the plurality of selections identifies a plurality of time series data elements; correlate the plurality of selections with a plurality of workflows, wherein each workflow of the plurality of workflows defines a set of associated time series data elements; identify a first workflow of the plurality of workflows associated with the plurality of selections; retrieve a first set of time series data elements associated with the first workflow; and identify an event using the first set of time series data elements.
An eighteenth aspect can include the system of the seventeenth aspect, wherein the plurality of time series data elements is received from a plurality of sensors, a plurality of edge devices, or a combination thereof.
A nineteenth aspect can include the system of the seventeenth or eighteenth aspect, wherein each workflow of the plurality of workflows is associated with an event for a process.
A twentieth aspect can include the system of the nineteenth aspect, wherein each workflow is associated with at least one detection model for the event associated with a corresponding workflow.
A twenty first aspect can include the system of any one of the seventeenth to twentieth aspects, wherein the processor is further configured to: receive, by a processor, a second plurality of time series data elements, wherein the plurality of time series data elements is a subset of the second plurality of time series data elements; and provide, by the processor on the user interface, a selection of the second plurality of time series data elements to the user, wherein the plurality of selections is chosen from the selection of the second plurality of time series data elements.
A twenty second aspect can include the system of any one of the seventeenth to twenty first aspects, wherein the processor is further configured to: present, on the user interface, at least one time series data element within the first set of time series data elements associated with the first workflow not within the plurality of selections from the user; and receive, on the user interface, a selection of the at least one time series data element by the user, wherein the selection indicates that the at least one time series data element is related to the plurality of selections.
A twenty third aspect can include the system of any one of the seventeenth to twenty second aspects, wherein the processor is further configured to: receive, on the user interface, a second plurality of selections, wherein the second plurality of selections identifies a second plurality of time series data elements; correlate the second plurality of selections with the plurality of workflows; identify a second workflow of the plurality of workflows associated with the second plurality of selections; retrieve a second set of time series data elements associated with the second workflow; and identify a second event using the second set of time series data elements.
A twenty fourth aspect can include the system of the twenty third aspect, wherein at least one time series data element is the same in both the plurality of time series data elements and the second plurality of time series data elements.
A twenty fifth aspect can include the system of the twenty third or twenty fourth aspect, wherein event and the second event are different events.
A twenty sixth aspect can include the system of any one of the seventeenth to twenty fifth aspects, wherein the processor is further configured to: determine, using the first set of time series data elements at a first time, a baseline for the first set of time series data elements; and determine, using the first set of time series data elements at a second time, that the first set of time series data elements exceed the baseline, wherein detecting the event is based on the first set of time series data elements exceeding the baseline.
A twenty seventh aspect can include the system of the twenty sixth aspect, wherein the processor is further configured to: provide, on the user interface, an indication the first set of time series data elements associated with the first workflow exceed the baseline; receive, on the user interface, feedback on the indication; and update the baseline based on the feedback.
A twenty eighth aspect can include the system of any one of the seventeenth to twenty seventh aspects, wherein the first workflow is associated with a first learning model, and wherein the processor is further configured to: input the first set of time series data elements into the first learning model; receive an output from the first learning model; and detect the event using the output from the first learning model.
A twenty ninth aspect can include the system of any one of the seventeenth to twenty eighth aspects, wherein each workflow of the plurality of workflows is associated with a learning model.
A thirtieth aspect can include the system of any one of the seventeenth to twenty ninth aspects, wherein the processor is further configured to: generating a second plurality of time series data elements, wherein the second plurality of time series data elements comprise at least one test data set; using the first workflow with the second plurality of time series data elements; and identifying a second event using the first workflow with the second plurality of time series data elements.
A thirty first aspect can include the system of any one of the seventeenth to thirtieth aspects, wherein the processor is further configured to: using at least one of the plurality of workflows as a digital twin.
In a thirty second aspect, a method for knowledge graph generation comprises: receiving a plurality of queries from a plurality of users, wherein the plurality of queries request time series data elements from a plurality of time series data elements; correlating the user queries between two or more users of the plurality of users; determining that the user queries of the two or more users of the plurality of users are correlated; correlating the time series data elements in the user queries of the two or more users; identifying a set of time series data elements based on the correlating; and generating a knowledge graph, wherein the knowledge graph comprises the set of time series data elements as facts, and the correlation of the time series data elements as relationships between the facts.
A thirty third aspect can include the method of the thirty second aspect, further comprising: correlating the time series data elements to at least one machine learning model from a plurality of machine learning models; and adding the at least one machine learning model to the knowledge graph.
A thirty fourth aspect can include the method of the thirty third aspect, further comprising: using the time series data elements as input to the at least one machine learning model, and outputting, from the at least one machine learning model, an identification of an anomaly.
A thirty fifth aspect can include the method of the thirty third aspect, further comprising: using the time series data elements as input to the at least one machine learning model; and outputting, from the at least one machine learning model, an identification of an event.
A thirty sixth aspect can include the method of any one of the thirty second to thirty fifth aspects, wherein the plurality of time series data elements is received from a plurality of sensors, a plurality of edge devices, or a combination thereof.

While various embodiments in accordance with the principles disclosed herein have been shown and described above, modifications thereof may be made by one skilled in the art without departing from the spirit and the teachings of the disclosure. The embodiments described herein are representative only and are not intended to be limiting. Many variations, combinations, and modifications are possible and are within the scope of the disclosure. Alternative embodiments that result from combining, integrating, and/or omitting features of the embodiment(s) are also within the scope of the disclosure. For example, features described as method steps may have corresponding elements in the system embodiments described above, and vice versa. Accordingly, the scope of protection is not limited by the description set out above, but is defined by the claims which follow, that scope including all equivalents of the subject matter of the claims. Each and every claim is incorporated as further disclosure into the specification and the claims are embodiment(s) of the present invention(s). Furthermore, any advantages and features described above may relate to specific embodiments, but shall not limit the application of such issued claims to processes and structures accomplishing any or all of the above advantages or having any or all of the above features.

Additionally, the section headings used herein are provided for consistency with the suggestions under 37 C.F.R. 1.77 or to otherwise provide organizational cues. These headings shall not limit or characterize the invention(s) set out in any claims that may issue from this disclosure. Specifically and by way of example, although the headings might refer to a “Field,” the claims should not be limited by the language chosen under this heading to describe the so-called field. Further, a description of a technology in the “Background” is not to be construed as an admission that certain technology is prior art to any invention(s) in this disclosure. Neither is the “Summary” to be considered as a limiting characterization of the invention(s) set forth in issued claims. Furthermore, any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. In all instances, the scope of the claims shall be considered on their own merits in light of this disclosure, but should not be constrained by the headings set forth herein.

Use of broader terms such as comprises, includes, and having should be understood to provide support for narrower terms such as consisting of, consisting essentially of, and comprised substantially of. Use of the term “optionally,” “may,” “might,” “possibly,” and the like with respect to any element of an embodiment means that the element is not required, or alternatively, the element is required, both alternatives being within the scope of the embodiment(s). Also, references to examples are merely provided for illustrative purposes, and are not intended to be exclusive.

While preferred embodiments have been shown and described, modifications thereof can be made by one skilled in the art without departing from the scope or teachings herein. The embodiments described herein are exemplary only and are not limiting. Many variations and modifications of the systems, apparatus, and processes described herein are possible and are within the scope of the disclosure. For example, the relative dimensions of various parts, the materials from which the various parts are made, and other parameters can be varied. Accordingly, the scope of protection is not limited to the embodiments described herein, but is only limited by the claims that follow, the scope of which shall include all equivalents of the subject matter of the claims. Unless expressly stated otherwise, the steps in a method claim may be performed in any order. The recitation of identifiers such as (a), (b), (c) or (1), (2), (3) before steps in a method claim are not intended to and do not specify a particular order to the steps, but rather are used to simplify subsequent reference to such steps.

Also, techniques, systems, subsystems, and methods described and illustrated in the various embodiments as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

1. A method of workflow selection and event detection, the method comprising:
receiving, on a user interface, a plurality of selections from a user, wherein the plurality of selections identifies a plurality of time series data elements;
correlating the plurality of selections with a plurality of workflows, wherein each workflow of the plurality of workflows defines a set of associated time series data elements;
identifying a first workflow of the plurality of workflows associated with the plurality of selections;
retrieving a first set of time series data elements associated with the first workflow; and
identifying an event using the first set of time series data elements.

2. The method of claim 1, wherein the plurality of time series data elements is received from a plurality of sensors, a plurality of edge devices, or a combination thereof.

3. The method of claim 1, wherein each workflow of the plurality of workflows is associated with an event for a process.

4. The method of claim 3, wherein each workflow is associated with at least one detection model for the event associated with a corresponding workflow.

5. The method of any one of claim 1, further comprising:
receiving, by a processor, a second plurality of time series data elements, wherein the plurality of time series data elements is a subset of the second plurality of time series data elements; and
providing, by the processor on the user interface, a selection of the second plurality of time series data elements to the user, wherein the plurality of selections is chosen from the selection of the second plurality of time series data elements.

6. The method of any one of claim 1, further comprising:
presenting, on the user interface, at least one time series data element within the first set of time series data elements associated with the first workflow not within the plurality of selections from the user;
receiving, on the user interface, a selection of the at least one time series data element by the user, wherein the selection indicates that the at least one time series data element is related to the plurality of selections.

7. The method of claim 6, wherein the identifying of the first workflow is based on the selection of the at least one time series data element by the user.

8. The method of claim 1, further comprising:
receiving, on the user interface, a second plurality of selections, wherein the second plurality of selections identifies a second plurality of time series data elements;
correlating the second plurality of selections with the plurality of workflows;
identifying a second workflow of the plurality of workflows associated with the second plurality of selections;
retrieving a second set of time series data elements associated with the second workflow; and
identifying a second event using the second set of time series data elements.

9. The method of claim 8, wherein at least one time series data element is the same in both the plurality of time series data elements and the second plurality of time series data elements.

10. The method of claim 8, wherein event and the second event are different events.

11. The method of claim 1, further comprising:
determining, using the first set of time series data elements at a first time, a baseline for the first set of time series data elements;
determining, using the first set of time series data elements at a second time, that the first set of time series data elements exceed the baseline, wherein detecting the event is based on the first set of time series data elements exceeding the baseline.

12. The method of claim 11, further comprising:
providing, on the user interface, an indication the first set of time series data elements associated with the first workflow exceed the baseline;
receiving, on the user interface, feedback on the indication; and
updating the baseline based on the feedback.

13. The method of claim 1, wherein the first workflow is associated with a first learning model, and wherein detecting the event comprises:
inputting the first set of time series data elements into the first learning model;
receiving an output from the first learning model; and
detecting the event using the output from the first learning model.

14. The method of claim 1, wherein each workflow of the plurality of workflows is associated with a learning model.

15. The method of claim 1, further comprising:
generating a second plurality of time series data elements, wherein the second plurality of time series data elements comprise at least one test data set;
using the first workflow with the second plurality of time series data elements; and
identifying a second event using the first workflow with the second plurality of time series data elements.

16. The method of claim 1, further comprising:
using at least one of the plurality of workflows as a digital twin.

17. A system comprising:
a memory storing a workflow application; and
a processor, wherein the workflow application, when executed on the process, configures the processor to:
receive, on a user interface, a plurality of selections from a user, wherein the plurality of selections identifies a plurality of time series data elements;
correlate the plurality of selections with a plurality of workflows, wherein each workflow of the plurality of workflows defines a set of associated time series data elements;
identify a first workflow of the plurality of workflows associated with the plurality of selections;
retrieve a first set of time series data elements associated with the first workflow; and
identify an event using the first set of time series data elements.

18. The system of claim 17, wherein the plurality of time series data elements is received from a plurality of sensors, a plurality of edge devices, or a combination thereof.

19. The system of claim 17, wherein each workflow of the plurality of workflows is associated with an event for a process.

20. The system of claim 19, wherein each workflow is associated with at least one detection model for the event associated with a corresponding workflow.

21. The system of claim 17, wherein the processor is further configured to:
receive, by a processor, a second plurality of time series data elements, wherein the plurality of time series data elements is a subset of the second plurality of time series data elements; and
provide, by the processor on the user interface, a selection of the second plurality of time series data elements to the user, wherein the plurality of selections is chosen from the selection of the second plurality of time series data elements.

22. The system of claim 17, wherein the processor is further configured to:
present, on the user interface, at least one time series data element within the first set of time series data elements associated with the first workflow not within the plurality of selections from the user; and
receive, on the user interface, a selection of the at least one time series data element by the user, wherein the selection indicates that the at least one time series data element is related to the plurality of selections.

23. The system of claim 17, wherein the processor is further configured to:
receive, on the user interface, a second plurality of selections, wherein the second plurality of selections identifies a second plurality of time series data elements;
correlate the second plurality of selections with the plurality of workflows;
identify a second workflow of the plurality of workflows associated with the second plurality of selections;
retrieve a second set of time series data elements associated with the second workflow; and
identify a second event using the second set of time series data elements.

24. The system of claim 23, wherein at least one time series data element is the same in both the plurality of time series data elements and the second plurality of time series data elements.

25. The system of claim 23, wherein event and the second event are different events.

26. The system of claim 17, wherein the processor is further configured to:
determine, using the first set of time series data elements at a first time, a baseline for the first set of time series data elements; and
determine, using the first set of time series data elements at a second time, that the first set of time series data elements exceed the baseline, wherein detecting the event is based on the first set of time series data elements exceeding the baseline.

27. The system of claim 26, wherein the processor is further configured to:
provide, on the user interface, an indication the first set of time series data elements associated with the first workflow exceed the baseline;
receive, on the user interface, feedback on the indication; and
update the baseline based on the feedback.

28. The system of claim 17, wherein the first workflow is associated with a first learning model, and wherein the processor is further configured to:
input the first set of time series data elements into the first learning model;
receive an output from the first learning model; and
detect the event using the output from the first learning model.

29. The system of claim 17, wherein each workflow of the plurality of workflows is associated with a learning model.

30. The system of claim 17, wherein the processor is further configured to:
generating a second plurality of time series data elements, wherein the second plurality of time series data elements comprise at least one test data set;
using the first workflow with the second plurality of time series data elements; and
identifying a second event using the first workflow with the second plurality of time series data elements.

31. The system of claim 17, wherein the processor is further configured to:
using at least one of the plurality of workflows as a digital twin.

32. A method for knowledge graph generation, the method comprising:
receiving a plurality of queries from a plurality of users, wherein the plurality of queries request time series data elements from a plurality of time series data elements;
correlating the user queries between two or more users of the plurality of users;
determining that the user queries of the two or more users of the plurality of users are correlated;
correlating the time series data elements in the user queries of the two or more users;
identifying a set of time series data elements based on the correlating; and
generating a knowledge graph, wherein the knowledge graph comprises the set of time series data elements as facts, and the correlation of the time series data elements as relationships between the facts.

33. The method of claim 32, further comprising:
correlating the time series data elements to at least one machine learning model from a plurality of machine learning models; and
adding the at least one machine learning model to the knowledge graph.

34. The method of claim 33, further comprising:
using the time series data elements as input to the at least one machine learning model; and
outputting, from the at least one machine learning model, an identification of an anomaly.

35. The method of claim 33, further comprising:
using the time series data elements as input to the at least one machine learning model; and
outputting, from the at least one machine learning model, an identification of an event.

36. The method of claim 32, wherein the plurality of time series data elements is received from a plurality of sensors, a plurality of edge devices, or a combination thereof.
